(19) United States
(12) Patent Application Publication
(10) Pub. No.: US 2026/0133584 A1
(43) Pub. Date: May 14, 2026

(54) REAL-TIME LOCATION SYSTEM (RTLS) ENABLED HUMAN-ROBOT INTERACTION

(71) Applicant: Drobot, Inc., Greenville, SC (US)

(72) Inventor: Stijn J Van De Velde, Simpsonville, SC (US)

(73) Assignee: Drobot, Inc., Greenville, SC (US)

(21) Appl. No.: 19/328,204

(22) Filed: Sep. 14, 2025

Related U.S. Application Data
(60) Provisional application No. 63/694,282, filed on Sep. 13, 2024.

(51) Int. Cl. G05D 1/247; G05D 1/223; G05D 1/622; G05D 1/644; G05D 101/15

(52) U.S. Cl. CPC G05D 1/247; G05D 1/223; G05D 1/622; G05D 1/644; G05D 2101/15

(57) ABSTRACT

Real-Time Locating System (RTLS) enabled human to automated vehicle interaction apparatus and methods. Systems may include a control system configured to communicate with RTLS transceivers and anchors within an environment, and autonomous vehicles (AVs) equipped with sensors and RTLS communication transceivers. A control system determines a real-time location of RTLS transceivers (“Tags”) and provides navigation, task, and behavioral instructions to AVs based on location data. RTLS transceivers can be worn by humans or attached to objects, machines, equipment, floorspace, storage bins, or other destination, thereby enabling AVs to locate and travel to humans, objects, or other destination points, perform tasks based on location data, and dynamically alter actions and behaviors. Locating and traveling to destination points may include dynamic destination points based upon movement of a destination human or item. User interactions via RTLS tags may trigger specific actions, enhancing human-automated vehicle collaboration and operational efficiency in diverse environments.

### FIELD OF THE DISCLOSURE

The present disclosure relates to apparatus and methods to control or guide navigation and operation of an automated vehicle or person (herein referred to as VOP) through an environment. More specifically, the present invention provides systems and methods for humans and robots, such as mobile robots and other kinds of autonomous vehicles, to interact and collaborate with each other, using RTLS Tags that are part of a real-time locating system (RTLS).

### BACKGROUND OF THE DISCLOSURE

In the realm of modern automation, systems such as Automated Guided Vehicles (AGVs), Autonomous Mobile Robots (AMRs), drones, and even humanoid robots, have become increasingly prevalent. However, such systems, here collectively referred to as “Automated Vehicles” (AVs), often require extensive integration and configuration to perform useful activities. The complexity arises from the need to tailor the automated systems to specific environments and tasks, necessitating significant upfront investment in time, resources, and expertise. The challenge of configuring these systems magnifies by their reliance on other automated systems, such as WMS and MES, to trigger their operations, limiting their adaptability and responsiveness in dynamic settings.

Current robots are focused on performing routine and repeatable tasks, and the current automation systems are designed with a narrow focus on performing pre-scheduled tasks or responding to commands from other integrated systems. Humans do not have simple and effective ways to interact with those robots, for example, to ask them to perform certain tasks on demand, when and where those unscheduled tasks are needed. As a result, the existing systems restrict their utility to a limited range of highly predictable, high-volume environments. These systems are typically “single purpose,” optimized for executing specific, and repetitive tasks that do not require significant flexibility or adaptability. As a result, they struggle to function effectively in more complex or variable environments, such as Manufacturing job shops and other low-volume, high-mix production environments, where tasks and conditions may change frequently.

Another significant limitation of existing technologies includes the lack of collaborative capabilities of currently available automation systems, such as mobile robots, with human workers. Currently available systems are not designed to interact with humans in a user-friendly or intuitive manner, leading to inefficiencies and potential safety concerns. The absence of effective human-robot communication methods further complicates the integration of these systems into workplaces where human robot collaboration is essential. Consequently, many companies experience the implementation of existing automation systems as a complex task, which renders those systems inaccessible despite their potential benefits.

Previously mobile robots typically only travel between pre-determined, fixed locations, such as specific workstations, whereas an ability to travel between more dynamic locations, including directly between people who may be moving around the environment, can often be very valuable.

To maximize their utility, contemporary mobile robots, such as automated guided vehicles (AGVs) and autonomous mobile robots (AMRs), must be seamlessly integrated with other automation equipment within their operating environment, including machinery and conveyor systems. This integration is crucial for enabling these robots to effectively coordinate their actions, such as determining the optimal time and location for material retrieval. However, achieving such integration often presents significant challenges, including the need for specialized engineering expertise and substantial financial resources. Furthermore, the integration process may be time-consuming.

### SUMMARY OF THE INVENTION

Accordingly, the present invention provides methods and apparatus for the use of one or more Real-Time Location Systems (RTLS) or other wireless location modalities to reduce the need for systems integration and simplify interaction between humans and robots. By using RTLS tags spatially associated with automated vehicles and/or people (sometimes referred to herein as “VOPs”), and other RTLS tag supportable objects, VOPs, including one or more of: autonomous mobile robots; other types of autonomous vehicles; and user controlled apparatus may be triggered to perform tasks on-demand, without requiring pre-determined schedules or fixed locations. The present invention provides for more flexible and intuitive collaboration between humans and robots or other automation, making it easier for robots or other automation to assist in multiple types of diverse activities. The apparatus and software enabled processes of the present invention enable robots and/or other vehicles to operate autonomously and flexibly, breaking free from the constraints of pre-determined schedules, routes, and/or stations. The RTLS based methods enhance the utility of the robots in diverse environments.

The disclosed systems include control systems configured to communicate with a plurality of RTLS transceivers, RTLS anchors, user devices, and AVs equipped with sensors and RTLS communication transceivers. These control systems determine the real-time location of RTLS transceivers, which may be worn by People 110 or attached to objects, and generate location data at multiple points in time. Based on this location data, the control systems provide navigation instructions to AVs, allowing them to travel to fixed or dynamic locations, follow humans or objects, and perform tasks on-demand without requiring pre-determined schedules or fixed interaction points.

The apparatus and methods further enable AVs to interact with humans in a user-friendly and intuitive manner, including following People 110 or objects carrying RTLS transceivers, collaborating on tasks, and adjusting their travel path, speed, and stop position in response to the actions and behaviors of humans and other mobile equipment. The control systems and AVs are capable of dynamically altering actions and behaviors based on real-time location data, predicted future locations, and additional sensor data. AVs can autonomously identify and transport objects, engage with accessories, and perform tasks based on metadata or specific properties associated with RTLS transceivers.

RTLS transceivers may trigger specific actions in AVs when entering or leaving designated geofenced areas, and AVs may follow virtual approved pathways within the environment to enhance operational flexibility and safety. The apparatuses and methods also support user interaction through RTLS transceivers equipped with buttons that trigger specific actions or behaviors in AVs, and the control systems can send notifications and alerts to user devices based on the real-time location of AVs and RTLS transceivers, including advance notifications based on predicted arrival times. AVs are enabled to perform collaborative tasks with People 110, operate autonomously in diverse environments, and respond to predicted actions of humans. The methods further detail steps for equipping AVs and humans or objects with RTLS transceivers, wirelessly communicating location data, determining real-time locations, and enabling AVs to perform a wide range of context-aware, on-demand, and collaborative tasks. Collectively, these apparatus and methods provide a flexible, scalable, and intuitive system for real-time human-robot collaboration, leveraging RTLS technology to enhance operational efficiency, safety, and adaptability in various environments.

Preferred embodiments include apparatus for enabling real-time location system (RTLS) based interaction between humans and autonomous vehicles (AVs) within a defined environment. The control system includes a processor and memory storing executable code, which is configured to communicate with a plurality of RTLS transceivers, RTLS anchors, and user devices. Autonomous vehicles are equipped with RTLS communication transceivers to interact with the control system. The control system determines the real-time location of the RTLS transceivers and generates location data at multiple points in time, providing navigation instructions to the AVs and assigning tasks based on both real-time location data and metadata associated with the RTLS transceivers.

The control system is further capable of assigning priority levels to tasks and generating an order of task execution, dynamically updating virtual approved pathways in response to environmental changes detected by AV sensors and RTLS transceivers, and enabling AVs to autonomously select optimal travel routes based on both RTLS location data and sensor-derived environmental conditions. Historical location data from RTLS transceivers is aggregated and analyzed to optimize future AV task scheduling and routing. AVs can communicate with other autonomous vehicles and user devices to coordinate collaborative tasks using real-time RTLS data.

In some embodiments, the control system may generate and manage geofenced (e.g., safety) zones that trigger AV behavioral modifications when RTLS transceivers enter or exit such zones. AVs utilize machine learning algorithms to adapt their behaviors over time based on interactions with People 110 and tracked objects. Real-time visualizations of AV and RTLS transceiver locations, including dynamic updates of virtual pathways and geofenced areas, are provided on user devices. AVs can autonomously engage and disengage with mobile accessories or carts equipped with RTLS transceivers based on task assignments and location data.

Context-aware notifications, including alerts for potential collisions, requests for assistance, and updates on AV task status, are sent to People 110. AVs adjust operational parameters such as speed, orientation, and stop position based on real-time proximity to People 110 and other mobile equipment. The control system stores and manages metadata associated with RTLS transceivers, including user preferences, task types, and destination information, enabling personalized AV interactions. AVs perform context-dependent signaling, such as light or sound alerts, when approaching People 110 or entering designated zones.

Remote control or guidance of AVs by People 110 may be enabled via user operated smart devices, with real-time feedback provided through RTLS location tracking. AVs autonomously identify and avoid obstacles within the environment by combining RTLS location data with sensor inputs from cameras, LiDAR, or other detection devices.

In some embodiments, a control system manages multiple environments and coordinates AV operations across geographically distributed locations using RTLS data. AVs execute multi-step collaborative workflows with People 110, including pick-up, delivery, and assistance tasks, triggered by RTLS transceiver events.

Some embodiments include a control system operative to dynamically reassign AV tasks in response to changes in Person 110 availability or location, and AVs maintain minimum approach distances and adjust their behaviors based on user preferences stored in RTLS transceiver metadata.

The control system may integrate RTLS location data with enterprise resource planning (ERP) or manufacturing execution systems (MES) to automate material handling and workflow processes, providing a comprehensive and adaptive solution for human-AV collaboration in dynamic environments.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale; emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates a block diagram of exemplary network architecture capable of controlling or guiding a VOP (e.g., an Automated Vehicle, such as a mobile robot; and/or a Person), using a Real-Time Location System (RTLS), in accordance with embodiments of the present invention.

FIG. 2A illustrates a schematic representation of exemplary environment including an RTLS Tag capable of being operative to communicate with one or more RTLS communication Anchors, in accordance with some embodiments of the present disclosure.

FIG. 2B is a schematic representation of other exemplary environments including a plurality of VOPs co-located with one or more respective RTLS Tags, which are operative to communicate with the one or more RTLS Anchors, in accordance with some embodiments of the present invention.

FIGS. 3A-3B illustrate schematic representations of exemplary environments including exemplary VOPs co-located with an RTLS Tag which is being detected by another VOP, in this case a mobile robot, in accordance with an embodiment of the present invention.

FIGS. 3C-3D illustrate schematic representations of exemplary environments including exemplary VOPs co-located with an RTLS Tag detected by another VOP, (as illustrated a mobile robot, in accordance with some embodiments of the present invention.

FIGS. 4A-4B illustrate schematic representations of exemplary virtual pathways that may be used by VOPs, and especially mobile robots.

FIGS. 4C-4E illustrate schematic representations of exemplary virtual pathways with a cart en route on the virtual pathway.

FIG. 5 illustrates a block diagram of an exemplary control system, including multiple hardware components capable of one or both of controlling and guiding VOPs.

FIG. 6, FIG. 6A, and FIG. 6B illustrate exemplary method steps that may be implemented in some embodiments of the present invention.

Those skilled in the art will appreciate that elements in the figures are illustrated for simplicity and may are not drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

The present invention provides apparatus and methods for enabling real-time location system (RTLS) based interaction between humans and autonomous vehicles (AVs) in a dynamic environment. The apparatus and methods include a control system configured to communicate with RTLS transceivers, RTLS anchors, and user devices, as well as AVs equipped with RTLS communication transceivers. By determining real-time locations and generating location data, the control system provides navigation instructions and assigns tasks to AVs based on both current location data and metadata. The system further supports advanced features such as task prioritization, dynamic pathway updates, collaborative workflows, geofenced safety zones, machine learning-based behavioral adaptation, context-aware notifications, and integration with enterprise resource planning (ERP) and manufacturing execution systems (MES), thereby facilitating efficient, flexible, and safe human-AV collaboration across diverse operational scenarios.

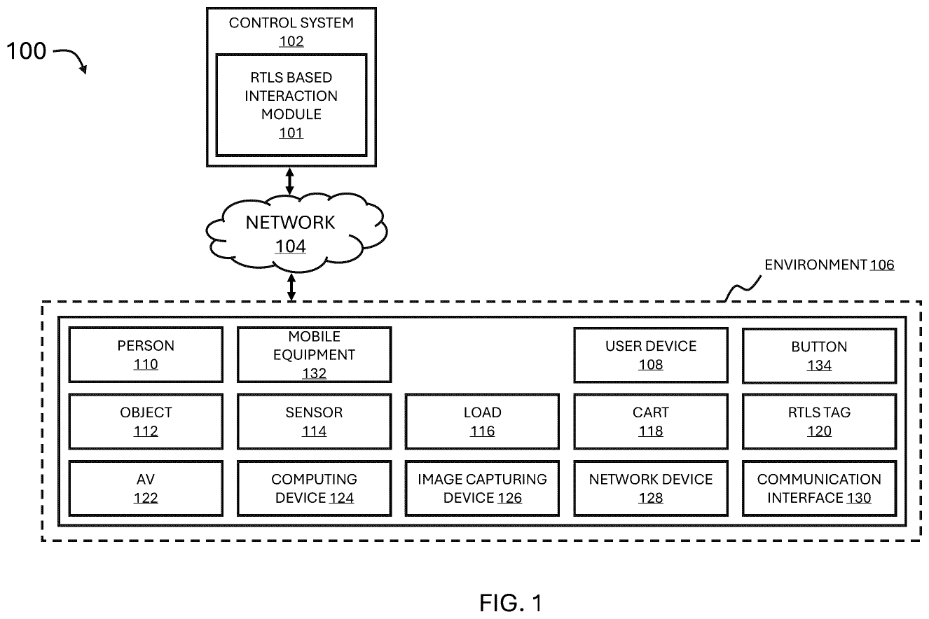

Referring now to FIG. 1, a block diagram illustrates an exemplary network architecture capable of controlling or guiding an Autonomous Vehicle, such as a Mobile Robot, using a Real-Time Locating System (RTLS), in accordance with embodiments of the present disclosure. The Network Architecture 100 may include a Control System 102 communicatively coupled to an Environment 106 via a Network 104. The Control System 102 may further be connected to one or more User Devices 108A-N (collectively referred to as User Devices 108A-N) via the Network 104 (also referred herein as Communication Network 104).

The Environment 106 may include, by way of non-limiting example (in their entirety or a portion thereof), one or more of: a manufacturing facility or other industrial environment, a warehouse, a construction site, a clinic or hospital, a quantified collection of multiple dwellings, such as one or more of: a retirement community, an eldercare facility, a school, a mall or store or other shopping area, a restaurant, an entertainment space, a public area, a city environment, or other indoor or outdoor defined area. In some embodiments, an Environment 106 may be geographically distributed.

Environment(s) 106 may include different types or classes of Assets such as, for example, but not limited to, one or more of materials, equipment, machines, Sensors 114, actuators, VOPs 110, 122 (also referred herein as Vehicles or Persons 110, 122, or Vehicles or People 110, 122), one or more Loads or Load Objects 116, one or more Carts or Cart Objects 118, and one or more Autonomous Vehicles such as Mobile Robots 122, one or more Computing Devices 124, one or more Real-Time Locating System (RTLS) Tags 120 (also referred herein as Tags), one or more image capturing devices 126 (such as for example, but not limited to, one or more of: cameras, image sensors, surveillance cameras, vision camera, or other electronic or electro mechanical device), network devices 128, communication interfaces 130, and tother electronic device.

Some of the pluralities of Objects 112 may be capable of communicating with the Control System 102 using respective Communication Interfaces 130 via communication links, such as for example, but not limited to, the Internet or a Network 104 which could be a Local Area Network, a Wide Area Network, or any other type of network. Also, the plurality of Objects 112 are capable of communicating with each other using respective Communication Interfaces 130 via communication links (not shown). The communication links may be wired or wireless links.

Further, in the Environment 106, some of the said Assets may not be capable of directly communicating with the Control System 102. For example, the plurality of Objects 112 may be one or more parts, tools, fixtures, carts, pallets, boxes, bins, trays, folders, pallet jacks, forklifts, tugger trains, scissor lifts, boom lifts, or the like. In some embodiments, the plurality of Objects 112 may carry RTLS Tags 120 which may be used to track and communicate their real-time location to the Control System 102 and, which may be used to communicate some or all of the Sensor data collected by some of the Objects to other Objects and/or to a Control System 102, which may then relay some of the data to some or all of the other Objects present or active within the same Environment 106, and/or to other Control Systems.

Some of the plurality of Objects 112 may have an operating system or other executable software that is executable upon command to perform one or more desired operations in the Environment 106. The plurality of Objects 112 may also run software applications that make the Objects 112 operative to collect and pre-process or process, one or more of: Environment data, Sensor data, Location data, image data, audio data, light frequency data, radiation data, or other data that may be quantified by a sensor 114 or other device or apparatus. The objects may be additionally operative via execution of software commands to transceive one or more of: collected data, pre-processed data, and processed data, to one or more of the Control System 102, a RTLS tag 120.

Transceiving from the Objects 112 may be undertaken on one or more of: a periodic basis, in response to a request, in response to an environmental condition, in response to a condition being met (e.g., a time lapse since last communication with another wireless device, or other condition. Transceiving may include one or both of wireless communication, light based communications, and hardwired communications.

In some embodiments, AVs 122 may include one or more of: Stationary Robots, Autonomous Vehicles, Mobile Robots, Drones, Humanoid Robots, and other autonomous mobile devices. Persons 110 may include People 110, carrying one or more of: an Object 112, a User Device 108A-N, an RTLS Tag 120, and one or more Sensors 114. Objects 112 may include one or both of: movable items and items fixedly secured in a position relative to a supporting surface.

Control System 102 may exist on a remote server such as, for example, a web server, or a cloud infrastructure capable of providing cloud-based services such as data storage services, data processing services, data analytics services, and data visualization services The Control System 102 may be part of a public cloud or a private cloud. Alternatively, the Control System 102 may also reside within the Environment 106. The Control System 102 may run on one or more of: a controller, a personal computer, a workstation, a virtual machine running on host hardware, a microcontroller system, and an integrated circuit. As an alternative, the Control System 102 may run on a real group of computers, sometimes referred to as a “cluster”, or a virtual group of computers, sometimes referred to as a “cloud”.

As used herein, a Network 104 may include, but is not limited to, a multi-service access network (MSAN) (such as a digital subscriber line (DSL), a passive optical network (PON), or Ethernet), a wireless mesh network (such as wireless fidelity (Wi-Fi), worldwide interoperability for microwave access (WiMAX), or cellular), a hybrid fiber-coaxial (HFC) network, a multi-access edge computing (MEC) network (such as cellular, Wi-Fi, and wired connections), a software-defined wide area network (SD-WAN) (such as multiprotocol label switching (MPLS), broadband internet, and cellular networks). Further, the Network 104 may include, but is not limited to, an Internet of things (IoT) network (cellular, low-power wide-area network (LPWAN), Wi-Fi, or Ethernet), a hybrid Network (such as a mixture of fiber optics, DSL, cable, and wireless connectivity options), a campus network (such as ethernet, fiber optics, wireless technologies (for example Wi-Fi)), a metropolitan area network (MAN) (such as fiber optics, ethernet, MPLS, and wireless connections), a carrier-grade network (such as fiber optics, DSL, cable, wireless (such as 4G/5G cellular networks), and satellite), a mobile network operators (MNOs) (such as 2G, 3G, 4G LTE, 5G, new radio (NR) and 6G), a power line communication (PLC) network, any other network, and a combination thereof.

The User Devices 108A-N may include, but are not limited to, a smartphone, a mobile phone, a personal digital assistant, a tablet computer, a phablet computer, a smart watch or other type of wearable device, a computer, a laptop computer, an augmented/virtual reality device (AR/VR), an internet of things (IoT) device, an edge device, a camera, and any other combination thereof.

It should be appreciated that the Network Architecture 100 and the Control Systems 102 that are depicted in FIG. 1 may be a few examples of implementations. Hence, the Network Architecture 100 may or may not include additional features, and some of the features described herein may be removed and/or modified without departing from the scope of the Network Architecture 100 outlined herein.

In some examples, the Network Architecture 100 may also include a private network and/or public network. The private network and/or public network may include any variations of networks. For example, the private network may be a local area network (LAN), and the public network may be a wide area network (WAN). Also, the private network and/or public network may each be a local area network (LAN), wide area network (WAN), the Internet, a cellular network, a cable network, a satellite network, or other networks that facilitate communication between the components of Network Architecture 100 as well as any external element or system connected to the private network and/or public network. The private network and/or public network may further include one, or any number, of the example types of networks mentioned above operating as a stand-alone network or in cooperation with each other. For example, the private network and/or public network may utilize one or more protocols of one or more clients or servers to which they are communicatively coupled. The private network and/or public network may facilitate the transmission of data according to a transmission protocol of any of the devices and/or systems in the private network and/or public network. Although each of the private network and/or public networks may be a single network, it should be appreciated that in some examples, each of the private network and/or public networks may include a plurality of interconnected networks as well.

In a preferred embodiment, the Control System 102 is capable of controlling or guiding the People 110, AVs 122, and/or Objects 112 based on RTLS Tags 120. The Control System 102 may include an RTLS-based Interaction Module 101. In an example embodiment, the RTLS-based Interaction Module 101 is configured to enable AVs 122 to find and travel between fixed or dynamic Locations within the Environment 106. The Locations can be determined through the location of associated RTLS Tags 120. Hence, AVs 122 may travel between, for example, People 110 and/or mobile workstations within the Environment 106, no matter the location of those People and/or workstations.

Further, the RTLS-based Interaction Module 101 is configured to enable AV 122 to also detect People 110, wherever they are in the Environment 106. Hence, using RTLS, AVs 122 may transfer items not only between fixed (or mobile Locations or) workstations, but also directly between People 110. This allows People 110 to request AVs 122 to fetch Objects 112 not just from certain (locations or) workstations, but also directly from certain People 110. Alternatively, the AVs 122 may be configured to take certain Objects not just to certain (locations or) workstations, but also directly to certain People 110.

Further, the RTLS-based Interaction Module 101 is configured to enable the AV 122 to be “alerted” or “triggered” to perform a certain Task (for example, to go pick something up) whenever one or more (specific) RTLS Tags 120 for example enter or exit a certain Area (a “Geofenced Zone”) or whenever one or more (specific) RTLS Tags 120 move within or outside some defined distance from some designated Location within the Environment 106. The RTLS Tags 120 are typically associated with certain (useful) Objects 112, such as work orders, tools, or fixtures, which an AV 122 is able to find, thanks to the Location information provided through the RTLS, and then for example, transfer between Locations.

The AVs 122 may also be “alerted” or “triggered” to perform one or more Tasks, and/or exhibit one or more behaviors, whenever one or more buttons 134 are being pressed or activated (in certain ways, in certain combinations, in certain locations, under certain circumstances or conditions, and/or at certain times) on one or more RTLS Tags 120, which may have specific meta data associated with them (incl. each RTLS Tags's unique tag number or Tag UID). In such embodiments, the RTLS Tags 120 involved may serve as “remote controllers” (e.g., sending (a) wireless signal(s) to some Control System, which then requests or triggers (a) certain (one or more) Task(s) to be performed by one or more AVs 122) and, additionally, the RTLS Tags 120 typically also have a known Location within the Environment 106 at the time when the buttons 134 are being pressed or being activated, allowing the AV 122 to act and/or behave in certain ways and/or to be aware of a specific Location to travel to, as part of the requested Task(s). In certain cases, and depending on the timing, circumstances, manner, sequence, combination, and/or locations of the Tag Buttons 134 that were pressed, an AV 122 will be made to act and/or behave in different ways, e.g. traveling to the Location of the RTLS Tag 120 at button-press time, versus traveling to the real-time “live” location of the RTLS Tag 120 on which one or more buttons 134 were pressed in certain ways. In certain cases, and depending on the manner, sequence, and/or combination of buttons 134 that were pressed, and the specific or general location, or Geofenced Zone, where or within the buttons 134 were pressed, and/or the time and/or certain specific circumstances present, an AV 122 will act and/or behave in certain ways, e.g. travel at different speeds to perform a certain triggered Task. The Tag buttons used need not always be physical switches; in some alternate embodiments, a button 134 may be a soft switch, e.g., on some UI, or it may be voice-controlled through a microphone which may be built into the Tag 120 or User Device 108 being used.

Using RTLS, and RTLS Tags 120, especially RTLS Tags 120 with one or more buttons 134, People 110 are able to interact with AVs 122 in very simple and effective ways, and able to request certain Tasks (such as “Transfer Tasks”) to be performed in very quick, easy, and effective ways. Without needing much, if any, of the “integration” that is typically required to make AVs 122 (such as mobile robots) useful, and without much, if any, of the more sophisticated Human-Robot interaction methods that are currently being developed using for example, but not limited to, artificial intelligence (AI) models, generative AI, Natural Language Processing, Large Language Models, or the like. For example, a certain RTLS Tag, possibly mounted on or otherwise integrated in the workstation of a Person 110, or mounted on or integrated into some Mobile Equipment operated by a Person 110, may be pre-configured to create a “Transfer Task”, any time a Person 110 presses a certain one or more buttons 134 on the Tag 120, in certain ways, causing an AV 122, to first travel to the location where the button 134 on the RTLS Tag 120 was pressed, wait for the Person 110 to place some item (e.g. Object or Load) onto the AV 122, and then take the item to the Destination (e.g., some defined Station or Zone) that is associated with the RTLS Tag 120 of which the button was pressed. The Destination information required to enable e.g. a Transfer Task, and many other necessary or useful parameters, can easily be associated with an RTLS Tag 120 as “label values” or other types of meta data, either stored onto the RTLS Tag 120 itself, or stored into the overall RTLS System, or stored into some other Control System, and associated with the specific RTLS Tag 120 involved via the RTLS Tag's unique ID. (“Tag UID”) The meta data associated with a certain RTLS Tag can be determined/configured “upfront”, based on some intended functionality (e.g. configuring certain RTLS Tags 120 to function as “Simple Transfer Tags”, associated with certain workstations and used to make AVs come to those workstations and then travel—while possibly transferring items- to certain other workstations), or such meta data can be dynamically determined/configured based on certain types of RTLS Tag button presses at certain times, under certain circumstances, in certain (geofenced) locations within the Environment, or such meta data can be dynamically determined/configured based on the current and/or prior locations of the RTLS Tags involved.

In an example embodiment, an AV 122 may collaborate with a Human operating a forklift (or any other Human-operated equipment) in a specified manner. The AV 122 may for example adjust its travel path and its stop (or pause/halt/stage) positions and orientations, based on the position and orientation of the forklift, in such way that the AV 122 may remain at a safe distance at all times, while placing itself in such way relative to the forklift (and the, for example, bin or crate or pallet sitting on top of the forks of the forklift) that the Person 110 is able to very easily and efficiently move parts from the (bin or crate or pallet placed on top of the forks of the) forklift to the box or bin or crate or pallet (or any other type of container or carrier) being carried, possibly on a Cart, by the AV 122. During this type of collaboration, the AV 122 preferably travels in a smart manner, e.g., taking into account People 110 Objects, and Obstacles within its environment and immediate surroundings, and making sure to minimize any risks and avoid any collisions.

In some exemplary embodiments, one or more AVs 122 may adjust AV 122 actions and behaviors (e.g., travel path, speed, position, and/or orientation) based on the actions and/or behaviors (including, for example, the known or predicted travel path, speed, position, and/or orientation) of one or more People 110 or the actions and/or behaviors (including, for example, the known or predicted travel path, speed, position, and/or orientation) of certain Mobile Equipment, whether singular or plural. Actions and behaviors may include, by way of non-limiting example, one or more of: a travel path, a travel speed, travel orientation, stop position, and AV orientation.

This Mobile Equipment may be autonomous (i.e., another Mobile Robot or some other type of AV) or the Mobile Equipment may be controlled by one or more People 110, whether directly or remotely. The travel path (or predicted travel path), speed, position, and orientation of People 110 and Mobile Equipment within the AV's Environment 106 may be determined and then used to control the AV's actions and/or behaviors through the (accurate and real-time) data provided by an RTLS to the Control System 102 or alternatively, through the data provided by an RTLS, combined with additional data from Sensors 114 such as, for example, but not limited to, Vision cameras, LiDAR, RADAR, Sonar, or other electronic or electro mechanical device, mounted on one or more of: a VOP, an AV, or other Object or infrastructure within the Environment 106.

The real-time data on actions and behaviors (including, for example, the known or predicted travel paths, speeds, positions, and/or orientations) of one or more People 110 and/or vehicles, including, for example, AVs, as provided through an RTLS, possibly combined with further sensor data from Vision cameras, LiDAR, RADAR, Sonar, or other electronic or electro mechanical device capable of quantifying a state within the Environment, may enable multiple AVs 122 to coordinate and collaborate with those People 110 and/or vehicles in real-time. One or more AVs 122 may for example be following the lead from one or more People 110, or one or more other vehicles, which may be AVs 122, and/or which may be controlled by one or more People 110, either directly or remotely. While being lead and controlled in such way, the AVs 122 may follow and respect the directions and control commands to the best of their ability, while taking into account certain circumstances related to their specific (individual) time and place, making sure that they do not run into any obstacles while trying to follow the directions and performing the commands provided.

Some practical applications of this may include a Mobile Robot (as an example of an AV 122) that grants right-of-way to a Person 110 on a Forklift, in order not to slow down or collide with the forklift, or a Mobile Robot (as an example of an AV 122) following a Person 110 that is operating a forklift to take storage bins from racks in a warehouse, to then pick certain parts from these storage bins and place them into a bin or cart being carried or pulled by the Mobile Robot. Another example of a practical application may include a (possibly smaller) cleaning robot following a (possibly larger) cleaning machine, which may be self-propelled and/or controlled by a Person 110, whereby the cleaning robot performs certain parts of the cleaning activity, for example, cleaning around the edges that are hard or impossible to reach by the (larger) cleaning machine. Yet another example of a practical application may include one or more robotic carts following a human-operated or autonomous tugger, without needing to be physically connected (“hitched”) together. Another example of a practical application may include a robot finding the best position and alignment to autonomously engage (and then pull or push) a Cart, based on the position and/or orientation of that cart as determined through an RTLS system, possibly augmented with further Sensor data, such as (for example) one or more vision cameras.

Some examples of human-robot interaction enabled through RTLS may include People 110 being asked to assist (i.e., help) an AV 122 whether by the AV directly, or by some Control System 102. Certain Tasks being performed by an AV 122 may require Person 110 assistance. For example, when an AV 122 is performing a pick-up or transfer Task, the AV 122 may need a Person 110's assistance to place a certain item (for example, a box or a bin with certain parts) on top of the AV 122, or to connect a certain Cart or accessory to the AV 122 upon the AV's arrival at some (intermediary destination) Location. By using an RTLS, and having People 110 wear RTLS Tags 120, the AV 122 or Control System 102 can know who the closest-by People 110 are—or are predicted to be—when the AV 122 arrives—or is close to arriving—at a certain Location where certain assistance will be required, using that knowledge to send a message or any form of signal (e.g., a Notification such as a request for assistance) to the one or more People 110 that are in the closest vicinity to that Location.

The Control System 102 may send these Notifications, such as requests for assistance, ahead of time, to give People 110 an advance notification of the help that will be required, trying to ensure that assistance will be there when and where needed. The Control System 102 may further anticipate when an AV 122 will be arriving at a certain Location, and which Person 110 is likely to be closest to that Location at that time, enabling the AV 122 or Control System 102 to send (one or more) advance notifications to the one or more selected People 110.

The Control System 102 will send these Notifications, such as requests for assistance, to the one or more specific People 110, based on a combination of one or more of the following: the specific one or more AVs involved, the specific one or more Tasks (or types of Tasks) being performed, the level of completion of the Tasks being performed, the predicted finish time of the Tasks being performed, the type of assistance required, the AVs current and/or predicted location, the Person 110's specific job roles and responsibilities, the Person 110's authority levels, the Person 110's current and/or predicted Location, the Person 110's current status or availability (e.g., “available to assist”), the Person 110's current task, the Person 110's current pipeline of tasks, the Person 110's personal preferences or other settings, the Person 110's prior answers to earlier Notifications and requests for assistance (e.g. “Declined”), and/or the Person 110's prior (and historical) performance related to earlier requests for assistance (e.g. did not show up, even though they had “Accepted” a request for assistance).

If useful, and possibly based on circumstances or personal preferences, the Control System 102 may send Notifications with certain (more or less complete or specific) information to selected People 110, e.g. when an AV would cross the path of a certain Person 110 who has expressed a desire to receive certain information when encountering an AV that may be working on some Task, or as part of a Notification such as a request for assistance. The communicated information may include, for example, the kind of assistance that will be required, the specific AV that will be requiring the assistance, the specific Location (e.g. Station) where the assistance will be required, the predicted or predicated time when the assistance will be needed, and the predicted amount of time remaining until the AV's arrival at the Location where the assistance will be required.

More than one request for assistance (or other notification) may be sent, for example periodically or based on certain time-based or other triggers. Parameters, possibly based on circumstances and/or Person 110 preferences may be defined within or communicated to the Control System 102. In certain embodiments, People 110 are able to “accept” or “decline” a request for assistance, as sent by an AV or the Control System involved. In case a certain Person 110 would decline a request for assistance, the AV or Control System can send a new request for assistance to one or more other People 110 that are being selected e.g., based on their current or predicted location relative to where the assistance will be needed at the predicted future time. In case no People 110 would “accept” a request for assistance within a certain amount of time, the AV or Control System will re-send the request for assistance, possibly sending the request to a different or wider range of People 110, selected based on e.g. their current and/or predicted locations, possibly combined with certain other parameters, such as their roles and status (e.g. “available” or “busy”). As soon as a first Person 110 accepts the request for assistance, the AV or Control System will cease to send out further requests for assistance. Instead, the AV or Control System will keep that Person 110 informed of the AVs location and Estimated Time of Arrival (ETA) at the Destination location where the assistance is being required. In case no Person 110 would be (avail)able (or willing) to provide the required support, the Control System may change the AV's Task or Route, e.g., postponing a certain Task until some later time when more People 110 may become available to assist.

Notifications, such as requests for assistance or alerts, will typically be sent to and shown (as e.g. text messages and/or pop-up notifications) on the mobile phones or tablet computers or smart watches or smart glasses (e.g., mobile devices and possibly “wearables”) carried or worn by certain/specific People 110, and/or to certain tablet computers or other computer stations that are present e.g. in the Mobile Equipment or at workstations used by those People 110, and/or to certain tablet computers or other computer stations that are present at any workstations that are at or near the AV's destination location, or that are associated with (“owned by”) e.g. the department that owns the destination location and/or for which the AV is carrying out the current Task. Some mobile or wearable devices may have RTLS tracking capability built into them, i.e., they may be sending out certain (e.g., BLE) signals that can be detected and interpreted (incl. triangulated or trilaterated) by an RTLS system present in the Environment. Some mobile or wearable devices may simply carry a passive RFID tag (or “RFID label”) that makes it possible to track them using RFID antennas positioned in the Environment. Some RTLS Tags have built-in screens that can be used to show Notifications or Requests for Assistance, without needing a further mobile or wearable device.

In case a certain Person 110 may be associated with a certain workstation or Mobile Equipment, notifications may be sent to both the computer (e.g. tablet computer) associated with the workstation and/or Mobile Equipment that the Person 110 is associated with and to the User Device (e.g. cell phone or tablet computer or smart watch or smart glasses) associated with (and typically carried or worn by) that Person 110. To avoid duplicate notifications, and depending on the (current and/or predicted) Location of a certain Person 110, as can be known by an RTLS based on the one or more RTLS Tags worn or carried by the Person 110, a request for assistance may be sent to just the personal User Device worn or carried by the Person 110, or to just the one or more User Devices (such as computer stations or tablet computers) associated with the (Destination) Location involved.

In some other examples, AVs 122 may inform People 110 of the Tasks on which they are working. When an AV 122 is performing a certain Task, it may typically be traveling through a certain Environment 106 in order to complete such Task. During its travels, the AV 122 may encounter People 110, who may be working within the same shared Environment. Some of those People 110 may be interested or have a need-to-know what Task(s) an AV 122 they encounter is working on. Also, in order to enhance trust between People 110 and AVs 122 operating within the same physical Environment, it is typically beneficial if the AVs 122 have a simple and effective manner to share information about the Tasks that they are working on with any People 110 that are present in close vicinity within the same Environment 106.

When a Person 110 is detected to be within a certain distance and relative position from an AV 122, e.g. known by the AV 122 and/or the Control System 102 through an RTLS Tag worn by the Operator, the AV 122 or the Control System 102 can send information about the specific Task(s) an AV 122 that the Person 110 encounters is working on, by sending relevant information to that Person 110's User Device (such as his/her smart watch or smart phone or tablet computer or smart glasses, or any other mobile or wearable devices) in the form of one or more text messages or pop-up notifications. When a Person 110, whether traveling by foot or operating some Mobile Equipment, is detected to be within a certain distance and relative position from an AV 122, and at risk of possible collision, e.g. known by the AV 122 and/or the Control System 102 through the one or more RTLS Tags worn by the Operator and/or the one or more RTLS Tags mounted on the Mobile Equipment being operated by the Person 110, the AV 122 or the Control System 102 can inform the Person 110 about the collision risk, so that corrective measures can be taken to avoid such collision.

Certain People 110 (or groups of People 110) may choose (or be selected) to receive such information, while other People 110 (or groups of People 110) may not receive the information. Different People 110 (or groups of People 110) may receive different information, depending on, for example, roles/responsibilities, circumstances, and/or preferences.

Different People 110 (or groups of People 110), based on, for example, their professional role or function, may choose or be selected to receive different (types of) information, or no information at all, depending on the kind of Task an AV 122 is working on, and/or the time of day, and/or the Location of the AV 122, whether absolute within the Environment and/or relative to the People 110 involved. All of the circumstances and preferences will typically be configurable within the overall Control System.

In some additional examples, timing AV Tasks based on the location of People 110 may be achieved. An AV 122 may be asked to perform a certain Task that requires the assistance of a Person 110. Certain Tasks may require the assistance of specific People 110, for example, depending on their role/responsibilities and/or qualifications. At times, it may not make sense for an AV 122 to initiate a certain Task when the Control System 102 knows that a matching Person 110 will not be present when the AV 122 is expected to arrive at the Location where the assistance will be required. Hence, depending on the current and/or predicted Location of certain People 110 within the Operating Environment, as determined by the RTLS System present in the Environment and e.g. the RTLS Tags 120 associated with the one or more People 110 involved, the Control System 102 may decide to hold off on “launching” a certain Task until it knows—or anticipates—a capable Person 110 to be present, or close enough to, the Destination Location of the AV 122, i.e., the Location where the AV will be needing Person 110 assistance.

In some embodiments, the Control System 102 may anticipate risks (“seeing around corners”) and send alerts. An AV 122 may be traveling in such way as to be obstructed from view for certain People 110 or certain other Mobile Equipment such as material handling equipment (for example, forklifts, tugger trains, AGVs, AMRs, and the like) operating within the same Environment 106. In case the People 110 or other Mobile Equipment are trackable by an RTLS, e.g. as they are outfitted with one or more RTLS Tags 120, the Control System 102 may make sure to modify the actions and/or behaviors of the AV in such way as to maintain a safe operation, for example, by adjusting speed and/or travel path to avoid a possible collision.

The AV 122 or Control System 102 may also proactively send a message to a Person 110, to make the Person 110 aware of the approaching AV 122, for example, by triggering an alert through the Person 110's User Device (e.g., cell phone, tablet computer, smart watch, smart glasses, or RTLS Tag). The Control System 102 may also proactively send messages and/or instructions to certain Mobile Equipment that may be approaching an AV 122. These messages may cause the Mobile Equipment to alter its actions and/or behaviors (for example, slowing down and/or changing course) to, for example, prevent a possible collision. A Person 110 may be walking or may be operating (i.e., driving) some kind of Mobile Equipment, such as a forklift or tugger or cleaning machine. In this case the messages may be sent to a Human Machine Interface mounted on the equipment being operated by the Person 110 and/or to the User Device carried or worn by the Person 110.

In additional examples, an AV 122 may need to minimize its relative distance to one or more People 110, AVs, or Objects while following those People 110, AVs, or Objects. The AV 122 and Control System 102 can use the Location information provided by the RTLS System present in the Environment, possibly including one or more RTLS Tags worn, carried, or mounted to the AVs, People 110, and/or Objects involved. The information provided by the RTLS System may be further augmented or enhanced with information provided by further Sensors such as vision cameras. While following a Person 110, AV, or Object, the AV 122 can be made to respect (“stick to”) the Approved Pathways present in the Environment, instead of being able to follow more freely, without such restrictions. When traveling freely, without having to respect the Approved Pathways, the AV 122 may either follow as efficiently as possible (attempting to keep its relative distance as small as possible at all times) or follow (mimic) the exact Travel Path taken by the Person 110 or Object. Whether sticking to Approved Pathways or not, the AV 122 will typically follow the Person 110 or Object in a “smart” manner, i.e., trying to follow the Person 110 or Object as efficiently as possible, while making sure not to run into anything while following. Instead of following a Person 110 or Object, an AV 122 can at times also be remotely controlled by a Person 110 or an automated Control System. Such remote control can again be aided by the real-time location data provided through an RTLS present in the Environment, and the RTLS Tags carried by or mounted on the AV, combined with further location data provided by additional Sensors such as vision cameras. In this case, the AV 122 can either be allowed to travel freely within the Environment, or it can be made to stick to (“respect”) Approved Pathways configured/present/available in the Environment, restricting the remote control to some extent. While being controlled remotely, the AV 122 can also be made to travel in a “smart” manner, for example, trying to follow the remote instructions as closely as possible, while making sure not to run into anything while performing those remote instructions.

In some embodiments, the Control System 102 is configured to identify and detect at least one of a VOP 110, 122 (such as a Person 110) and/or Object 112 co-located with an RTLS Tag 120, whereby the Control System 102 is configured to dynamically guide a Mobile Robot 122 to mimic a virtual path and pick up the at least one of a Person 110 and/or Object 112 autonomously.

In an embodiment, the RTLS Tags 120 are configured for tracking the real-time location of People 110 and/or Objects 112 within a specific Environment 106. By equipping the People 110 and/or Objects 112 with one or more RTLS Tags 120, the said location may be accurately determined and monitored over time. The implementation of RTLS Tags 120 enables interaction and collaboration between the People 110 and/or Objects 112 and the AVs 122. Further, with real-time Location data, the AVs 122 may respond dynamically to the presence and movement of People and Objects, facilitating more efficient and responsive operations. For example, an AV 122 may adjust its path to avoid a Person or deliver an Object to a specific Location based on the real-time positioning provided by the RTLS Tags 120.

Further, the said capability of the AVs 122, which may respond dynamically to the presence and movement of People and Objects, significantly enhances the potential for the People 110 and/or the Objects 112 and the AVs 122 to work together in more integrated and flexible ways. The use of RTLS Tags 120 allows the AVs 122 to operate in environments where the presence and location of the People 110 and/or Objects 112 are constantly changing, thereby supporting more complex and varied tasks. The said integration improves the efficiency of automated processes and also enables the AVs 122 to perform tasks that require a higher degree of situational awareness and adaptability.

Though few components and subsystems are disclosed in FIG. 1, there may be additional components and subsystems which are not shown, such as, but not limited to, ports, routers, repeaters, firewall devices, network devices, databases, network attached storage devices, user devices, additional processing systems, servers, assets, machineries, instruments, facility equipment, any other devices, and combination thereof. The person skilled in the art should not be limiting the components/subsystems shown in FIG. 1. Although FIG. 1 illustrates that the Control System 102 is connected to one Environment 106, one skilled in the art may envision that the Control System 102 may be connected to several Environments 106 located at same or various locations.

Those ordinary skilled in the art will appreciate that the hardware depicted in FIG. 1 may vary for particular implementations. For example, other peripheral devices such as an optical disk drive and the like, local area network (LAN), wide area network (WAN), wireless (for example wireless-fidelity (Wi-Fi)) adapter, graphics adapter, disk control system, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the Control System 102, as is unique to the present disclosure or necessary for an understanding of the present disclosure, is depicted and described. The remainder of the construction and operation of the Control System 102 may conform to any of the various current implementations and practices that were known in the art.

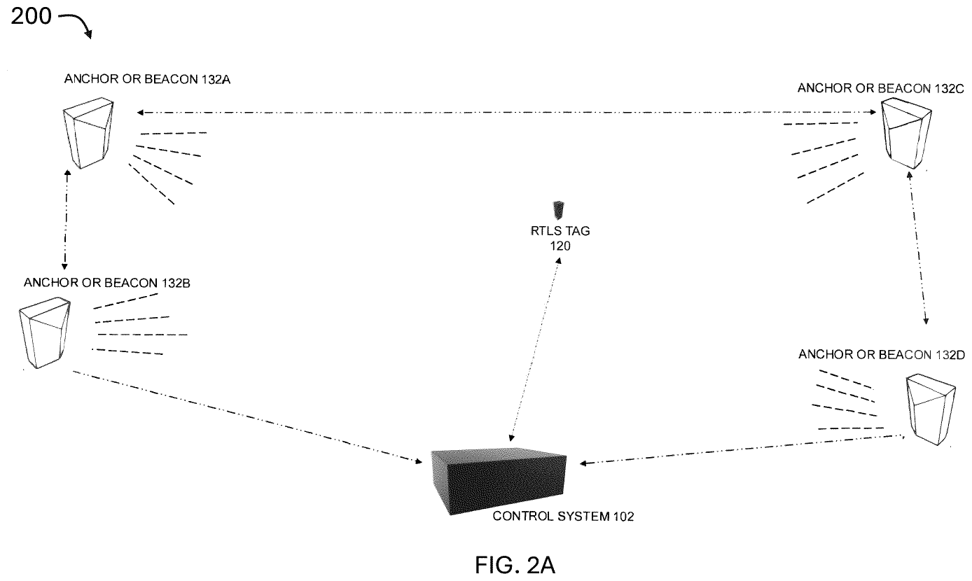

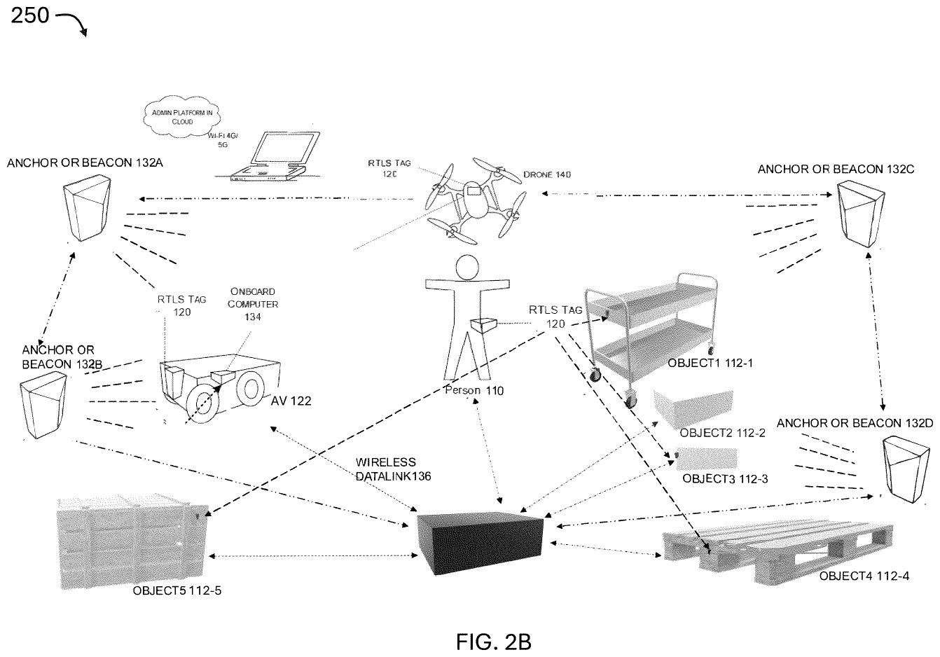

FIG. 2A is a schematic representation of an exemplary environment comprising an RTLS Tag 120 which communicates with one or more RTLS Anchors 132A-D The one or more RTLS Tags 120 may be in communication with Control System 102 via a wireless data link (not shown). The wireless datalink may include for example, but not limited to, RF signaling through UWB or BLE. The RTLS Tag 120 communicates with one or more RTLS Anchors 132A-N and the Control System 102 via the wireless datalink within the Environment 106. The wireless datalink communications may include timing signals, position data, movement instructions (for example acceleration, velocity, direction) origination points, destination points, or other information related to travel of People 110, Objects 112, or AVs 122 through the physical Environment 106. The RTLS Tags 120 are typically worn, carried, mounted, or otherwise attached to AVs, Objects, or People where the location and/or other information needs to be tracked. By emitting RF signals, which are received by the one or more RTLS Anchors 132 that are strategically placed throughout the Environment 106, the RTLS Tags 120 enable to triangulate their precise position.

In some embodiments, an RTLS Tag 120 may determine its own position, and hence a “Positioning Server” may not be always necessary. The Control System 102 may sometimes comprise an RTLS “Positioning Server”. This server may be some type of (industrial) computer, either on-premises or in the Cloud, equipped with certain software that determines the real-time position of some or all of the (active) RTLS Tags 120 in the Environment 106.

Further, the communication between RTLS Tags 120 and the RTLS Anchors 132 primarily occurs through radio frequency (RF) signals. Each of the RTLS Tag 120 periodically sends out a signal, which is captured by the surrounding one or more RTLS Anchors 132. The one or more RTLS Anchors 132, equipped with RF receivers, measure the time of flight, angle of arrival, signal strength, and/or other relevant parameters of the received signal. By processing the said parameters, the RTLS System may accurately determine the RTLS Tag's location within the Environment. 106 The process may be continuous, ensuring that the position of the RTLS Tag 120 is constantly updated in real-time with high levels of accuracy and reliability.

In some embodiments, an RTLS Anchor 132A-N may also be referred to as an RTLS “Antenna”, or “Anchor”, or “Beacon”, (with a fixed, or known, location within the Environment 106).

FIG. 2B is a schematic representation of another exemplary environment with multiple Autonomous Vehicles and/or Persons (VOP) 112 co-located with respective RTLS Tags 120 which communicate with the one or more Anchors 132A-N, in accordance with embodiments of the present disclosure. In some examples, the VOP 110, 122 may include an on-board Computer 134. The on-board Computer 134 may be configured to process some part of the data captured by the VOP 110, 122 via a sensor mounted on the VOP 110, 122. The on-board Computer 134 may also have network and communication interfaces (not shown) to communicate with the Anchors 132A-N and/or the Control System 102 or other VOPs 110, 122 within the Environment 106.

According to the present disclosure, one or more of: current position coordinates, “intermediate” destination position coordinates (for example, waypoints), and “final” destination coordinates may be generated as part of a sequence of positional coordinates to be travelled by the VOP 110, 122. The position coordinates may be generated by way of non-limiting example, via execution of software commands by the Control System 102 that receives values for timing variables involved in the Wireless Datalink 136 communications and performs location determining algorithms, such as one or both of trilateration and triangulation or the like. Some preferred embodiments include the Control System 102 to perform two way ranging (TWR) and/or time difference of arrival (TDOA) and/or reverse time difference of arrival (R-TDOA) and/or Angle of Arrival (AoA) protocols on respective wireless communications between the RTLS Tag 120 and at least four anchors including a first Anchor 132A, a second Anchor 132B, and a third Anchor 132C, or other Anchor 132N to determine a respective distance, such as, for example: between the RTLS Tag 120 and the first Anchor 132A, the second Anchor 132B, the third Anchor 132C, or the other Anchor 132N. With typically three or more respective distances between the RTLS Tag 120 and the Anchors 132A-N, one or both of triangulation and trilateration may be used to generate position coordinates for the RTLS Tag 120. The position coordinates may include, for example, X, Y, Z cartesian coordinates. The Control System 102 may generate the position coordinates associated with one or more VOP 110, 122, the Tag 120, a smart device, or other apparatus or device with a processor and memory. The position coordinates are preferably generated on a periodic basis, depending upon particular circumstances. For example, a slow-moving VOP 112 may have a longer period of time between generation of new position coordinates, which may conserve battery life and bandwidth, and a faster moving VOP 110, 122 may have a shorter period of time between determination of position coordinates. In some embodiments, a period of time between generation of the position coordinates may be based upon a projected and/or calculated velocity and/or acceleration of a VOP 110, 122, such that for example if the VOP 110, 122 is stationary, a period of time between generation of position coordinates may be two seconds, or more, and if the VOP112 is moving quickly, a period of time between generation of position coordinates may be one tenth (0.1) of a second, or less. The exemplary environment comprises multiple VOPs 110, 122 to navigate from source point to the destination point using the VAP. In an exemplary embodiment the person may be carrying one or more RTLS Tags 120.

The Control System 102 may generate a prescribed travel route comprising a series of current location point coordinates and destination point coordinates. The VOPs 110, 122 may report current location point coordinates to the Control System 102 and receive destination point coordinates for a next destination according to a periodic basis and/or upon a threshold. The threshold may be almost any quantifiable condition related to a VOP position and/or conditions within the Environment 106.

Some exemplary threshold may include, one or more of: reaching a position proximate to a destination point traveling a prescribed distance, remaining stationary for a prescribed period of time (dwell time), a travel trajectory of another VOPs 110, 122, a travel trajectory that may collide with an obstruction, or other event that may be a condition precedent to a change in one or more of, a set of destination coordinates (which may correlate with a next destination, or a subsequent destination), a velocity of travel of the VOPs 110, 122, an acceleration rate of the VOP112, a deceleration rate of the VOP112, a rate of change of direction included in a travel trajectory, reaching a maximum number of VOPs 110, 122 within a given set of position coordinates defining an area, experiencing a disrupting event within a given set of position coordinates defining an area (for example, a spill, hazard or other adverse condition), and a pause or other delay of travel.

Some embodiments may include the Mobile Robot 122 to detect VOPs 110, 122 that carry RTLS Tags 120 within the Environment 106. The Mobile Robot 122 may follow a VOPs 110, 122 that carries one or more RTLS Tags 120 within an Environment 106. The Mobile Robot 122 may be made to follow certain pre-determined pathways (such as “Virtual Approved Pathways”) or it may be made to follow (mimic) the exact travel paths taken by the VOPs 110, 122. While following certain VOPs along certain predetermined pathways, or while following certain VOPs along the same pathways as traveled by those VOPs, the Mobile Robot 122 may follow the VOPs 110, 122 in a “smart” manner, e.g., making sure not to collide with obstacles while following the VOP. The Mobile Robot 122 may detect one or more VOPs 110, 122 (including, for example, a Cart) that carry one or more RTLS Tags 120 within the Environment 106. Further, upon detecting the VOPs 110, 122VOPs 110, 122 and based on the RTLS Tag 120, the Mobile Robot 122 may possibly validate the VOPs' ID. Further, the Mobile Robot 122 can perform one or more tasks autonomously, for example, transporting a Cart to a destination location.

Some embodiments may include an AV 122 that follows a VOP 110, 122 for example, a forklift, a Mobile Robot, or a Cart pulled by a tugger or Mobile Robot, which carries an RTLS Tag 120. In such way, the AV 122 may be made to “platoon” by following one or more other AVs, or other mobile Objects carrying RTLS Tags 120. In this case, the AV 122 may be made to follow (mimic) the exact travel path taken by the VOP 110, 122 and/or it may be made to follow the Object in a “smart” manner”, including avoiding possible Obstacles (e.g., collisions with such Obstacles) along the way.

Some embodiments may include the AV 122 which may adapt one or more actions and behaviors based on real-time, accurate location data of RTLS-tracked VOPs 110, 122 or Objects 112 within the Environment. The said capability allows the AV 122 to dynamically respond to the presence and movement of various entities, including (other) robots, Humans, forklifts, tugger trains, etc. By continuously monitoring the location of these VOPs and/or Objects, the AV may make informed decisions to enhance safety and efficiency. For instance, if the AV 122 detects the VOPs 110, 122 or Objects in close proximity, the AV 122 may automatically slow down, stop, or adjust its trajectory to avoid collisions. Similarly, if the AV 122 identifies an Obstacle or a change in the Environment, it may reroute its path accordingly. The said level of responsiveness is crucial in Environments where the presence and movement of VOPS and Objects 112 are unpredictable, such as warehouses, manufacturing floors, or busy industrial settings. The ability to integrate real-time location data into its decision-making process allows the AV 122 to operate more safely and efficiently, ensuring smooth and coordinated interactions with both automated and human-operated systems.

Some embodiments may include the AV 122 which may dynamically alter the one or more actions and behaviors based on real-time data regarding the location of VOPs and/or Objects 112 within its Environment. The said capability enables the AV 122 to respond proactively to changes in its surroundings, enhancing both safety and efficiency in various applications. For instance, the AV 122 may be triggered to slow down, stop, or change its trajectory if it detects that a VOP or Object 112 is moving towards its path. By continuously monitoring the position of VOPs and/or Objects 112, the AV may anticipate potential collisions or other hazardous situations and adjust its movements accordingly. The AV's 122 ability to predict and anticipate the future location of the VOPs 110, 122 and/or Objects 112 is particularly valuable in Environments where both the People 110, AVs 122, and/or Objects 112, are in constant motion. By analyzing the trajectory and speed of VOPs and Objects 112, the AVs 122 may predict their likely positions in the near future. The said predictive capability allows the AV 122 to make informed decisions about how to navigate its Environment, such as altering its route or stopping to avoid a (moving) Obstacle and prevent a collision. This level of situational awareness is crucial for operating safely in dynamic, unpredictable Environments. Further, the integration of real-time location data into the AV's Control System 102 enhances its autonomy and adaptability. The AV 122 may operate more effectively in Environments where the presence of VOPs and/or (moving) Objects 112 creates variability. Instead of following rigid, pre-programmed paths, the AV 122 may make autonomous decisions that account for the current and predicted locations of the VOPs 110, 122 and Objects.

Some embodiments may include the AV 122 executing one or more Tasks or altering its behavior based on the location of one or more RTLS Tags 120 within its Environment. The Tags 120 are co-located to the VOPs 110, 122, and/or Objects 112 in the Environment 106, and communicate their position in real-time to the AV 122, possibly via a Control System 102. This enables the AV 122 to respond dynamically to changes within its surroundings. For example, when one or more RTLS Tags 120, with certain Properties (incl. certain meta data), enter or exit a Geofenced Area, at certain times, in certain ways, and/or under certain circumstances, the AV 122 may be triggered to initiate one or more specific actions, and/or exhibit one or more certain behaviors, such as initiating a certain (e.g. pickup or delivery) Task, sounding an alert, or adjusting its navigation path.

In some embodiments, the AV 122 may be triggered to initiate one or more specific actions, and/or exhibit one or more certain behaviors, when one or more RTLS Tags 120, with certain Properties (incl. certain meta data), (are made to) move within or outside (a) certain threshold distance(s) from (a) certain designated Location(s), at certain times, in certain ways, and/or under certain circumstances. Some embodiments may also allow the AV 122 to be triggered to initiate one or more specific actions and/or exhibit one or more certain behaviors. For example, when one or more RTLS Tags 120 move between two or more specific locations or zones within the Environment where the AV 122 is operating, e.g., into a first zone, if the AV 122 has not yet entered into the specified zone, then the AV 122 may be triggered to enter into another zone. Similarly, the AV 122 may be triggered to enter into one or more further zones, and potentially out of a last zone. Trigger capabilities allow an AV 122 to operate with increased autonomous actions, and intelligently whereby the AV 122 adapts to the AV's 122 actions and behaviors based on the real-time position and movements of VOPs and/or Objects within its Environment. By leveraging the location data from the RTLS Tags 120 in such manner, the AV 122 may perform complex, context-aware Tasks, in autonomous ways, without requiring the traditional kind of systems integration. For example: “kanban” replenishment systems whereby an Object 112, for example, a bin or a Cart that is equipped with an RTLS Tag 120 and/or RFID label is being put (typically by a Person 110 or by an AV 122, but possibly also through e.g. a conveyor system) in a certain Geofenced Area or Zone, or some area equipped with an RFID reader, thereby automatically triggering a “Transfer” (and possible “replenishment”) Task to be performed by an (available and capable) AV 122. For example: a Person 110 placing an Object 112, such as a bin or box, equipped with an RTLS Tag 120, in a certain area of the Operator's workstation, such as a Geofenced Area (or, some area equipped with an RFID reader), thereby automatically triggering a Transfer task to be performed by an (available and capable) AV 122. The Destination (e.g., Station or Zone) for such Transfer Task may be determined by certain Properties associated with the RTLS Tag 120 involved. For example, an RTLS Tag 120 may have a “Destination” label, with a defined value, determining the Destination that the AV 122 should travel to upon picking up the Object 112. Or, the Destination may be determined by the Tag UID of the RTLS Tag 120 used, for example when a certain RTLS Tag 120 is associated with a certain production order (or “work order” or “job”, or any other terminology being used in industry), then the Enterprise Resource Planning (ERP) system or the Manufacturing Execution System (MES) involved may determine the next operation on the routing of that production order, and thereby the next workstation—e.g., Destination—where the Object should be transferred to.

Certain Properties of the RTLS Tags 120 used can impact the actions and/or behaviors of AVs 122 when one or more such RTLS Tags 120 are placed in certain areas (e.g., within certain one or more Geofenced Zones or within a certain distance from certain one or more Locations) and/or when one or more buttons are being pressed, in certain ways and certain combinations, on one or more such RTLS Tags 120. The Properties of an RTLS Tag 120 are part of the meta data associated with that RTLS Tag 120 and can be stored, for example, as Tag Label Values, either on the RTLS Tag 120 itself, in the overall RTLS, or in a Control System 102. For example, an RTLS Tag 120 may have a Label Value “Task Type” equal to “Come,” which triggers a “Come” task to be created when one or more specific buttons on that RTLS Tag 120 are being pressed (possibly, in certain ways, at certain times, under certain conditions). As a result, the Control System 102 will create a “Come” task and assign it to an (available and cable) AV 122, causing that assigned AV 122 to travel to the Location of the RTLS Tag 120 of which the one or more buttons were pressed. This (Destination) Location may be determined e.g., by the specific buttons that were pressed, and/or the manner in which they were pressed. For example, pressing the Tag's button once may cause the AV 122 to come to the “live,” real-time Location of that Tag 120, whereas pressing the Tag's button twice may cause the AV 122 to come to the Location of the Tag 120 at the time when the Tag's button was pressed. And, pressing the Tag's button three times may cause an AV 122 to travel to a predefined Location associated with the Tag 120, such as the Tag's “home location,” which may be stored as the Tag's “Home Location” Label Value. Assigning another Label Value (such as another Station and/or another Location coordinate) to the “Home Location” Tag Label, would cause the AV 122 to travel to that (updated) Location instead. Moving an RTLS Tag 120 into a certain Location, or a certain series of Locations, within the Environment 106, e.g., within a certain distance of a certain Location, or within a certain Geofenced Zone, or through a series of Geofenced Zones, may cause certain Label Values of that RTLS Tag 120 to be updated automatically, depending on certain circumstances and logic (rules/algorithms) being applied. Which then may cause different actions or behaviors by an AV 122 being called upon to perform a certain Task when that RTLS Tag 120 is e.g., moved inside of a certain Geofenced Zone, or when e.g., certain buttons of that RTLS Tag 120 are being pressed at certain times, in certain places, and/or in certain ways. One of the Tag properties could be a priority level associated with the RTLS Tag 120, thereby transferring such priority level onto the Task being triggered by that specific Tag 120 (e.g., Tags with higher priority levels trigger Tasks with higher priority levels), whether by pressing one or more of the Tag's buttons or by moving the Tag in/out/between one or more geofenced Zones.

Some embodiments may include the AV 122 performing certain Tasks and/or exhibit specific behaviors based on the RTLS Tags 120 placed within designated Geofenced Areas of its Environment 106. By positioning the said RTLS Tags 120, or combinations of different RTLS Tags 120, in specific Locations, or removing them (again) from specific Locations, the AV 122 may be triggered to initiate a predefined set of actions and/or exhibit certain behaviors. For instance, when an RTLS Tag 120 enters a particular Geofenced Zone, possibly placed there by a Person 110, the AV 122 might start a Task such as inspecting or cleaning, possibly (in) some area different from the Geofenced Area. Conversely, if the Tag 120 leaves the area, the AV 122 may halt its activity or switch to another Task.

Some embodiments may include the AV 122 being triggered to perform one or more specific Tasks and/or behave in certain ways, by pressing one or more Tag Buttons on one or more RTLS Tags 120 in certain ways. For example, short vs. long button-presses, different series of button presses such as “short-short” or “long-long,” pressing different button combinations. The specific actions and/or behaviors performed and/or exhibited by the AV 122 may depend on the (absolute or relative) Location and/or movement of the AV 122 and/or the Location and/or movement of the RTLS Tags 120 involved, such as, for example, whether the AV 122 and/or the RTLS Tags 120 are within certain Geofenced Zones, the relative position of the AV 122 vs. the Tags 120, and the like, at the time of pressing the Tag Buttons. The AV 122 may respond differently (e.g., modify its actions and/or behaviors in certain ways) based on how a Tag 120 is “programmed”, when the buttons of that Tag 120 are pressed (in certain ways and/or in certain Locations)). “Programming” an RTLS Tag 120 may be as simple as changing certain Tag Label Values or other metadata values of an RTLS Tag 120. “Programming” an RTLS Tag 120 may also happen dynamically, whereby the RTLS Tag's Label Values are determined by the RTLS Tag's current location and/or (one or more) prior locations, including the order in which the Tag 120 entered or exited those prior locations. “Programming an RTLS Tag 120” may also happen through certain Tag Button presses in certain ways, at certain times, in certain locations, and/or under certain conditions.

Some embodiments may include the AV 122 behaving differently, when approaching and/or interacting with the VOPs 110, 122, based on the parameters associated with the one or more RTLS Tags attached to or being carried by the VOPs 110, 122. For example, a Person's RTLS Tag may make the AV 122 understand that specific Person's preferences related to possible Human-Robot interaction, including for example, how close the AV 122 may approach the Person, how slowly the AV 122 should pass the Person or rather stay behind the particular Person, in which ways the Person prefers to communicate with the AV 122.

An RTLS Tag 120 may have a user interface or UI, referred to as Tag UI, such as for example, a screen, which may provide information on an AV's 122 activity, intent, and/or needs. The Tag UI of the Tag associated with a VOP 110, 122 or Object 112 (such as a box, bin, pallet, or cart) may, for example, show that a Task was created for an AV 122 to come pick up the VOP 110, 122 or Object 112. The Tag UI of an RTLS Tag 120 used by a Person 110 may inform that Person 110 (User) carrying such Tag 120 that an AV 122 is underway and may need certain help upon arrival at a certain Destination Location, such as a certain Zone or Station. Alternatively, a User Device used by a Person 110, such as a mobile phone or tablet computer or smart watch or smart glass, can have an RTLS Tag 120 attached or built in, or otherwise function as an RTLS Tag 120, e.g., be located and tracked by the RTLS present in the Environment 106. In such case, relevant information may be shared with the Person 110 through such mobile or wearable device.

Some embodiments may include an AV 122 which may find an accessory (for example, a cleaning cart) co-located with an RTLS Tag 120, allowing the AV to find the accessory, to then (“auto”) engage that accessory to perform a certain Task (for example, cleaning). That way, the AV 122 may utilize the same accessory, without concern that the accessory may get lost.

When a Person 110 carries an RTLS Tag 120, an AV 122 may detect the Person 110 and use light and/or sound signaling to alert the Person 110 of its presence, thereby improving safety. The AV 122 may also acknowledge that Person 110's presence, and possibly even “show respect” to that Person 110, in certain ways, for example, by signaling with lights and/or sounds when the Person 110 and the AV 122 approach each other. The Person 110's RTLS Tag (at times referred to as User Tag) may identify the specific Person 110 involved, and allow the AV 122 to know that particular Person 110's preferences as to how he or she wants to be approached, acknowledged, treated, respected, and/or served.

Some embodiments may include an AV 122 behaving differently, when approaching and/or interacting with a Person 110, based on the parameters associated with an RTLS Tag 120 attached to or being carried by that Person 110. For example, a Person's RTLS Tag 120 (at times also referred to as a “User Tag”) may make an AV 122 understand that specific Person's preferences related to possible Human-AV interaction, incl. for example, how close the AV 122 may approach the Person 110, how slowly the AV 122 should pass the Person 110—or stay behind the particular Person 110, in which ways the Person 110 prefers to communicate with the AV 122. Practically, certain metadata values, or Tag Label Values, may be associated with the Tag 120 being carried by a certain Person 110, informing the AV 122 of the Person's preferences. For example, a Tag Label “Min. Approach Distance” may carry the Label Value “5 feet”, causing AVs 122 to maintain a minimum distance of 5 feet from that Tag 120. As such, when that RTLS Tag 120 is carried by a certain Person 110, any AVs 122 will be caused to maintain a minimum distance of 5 feet from that Person 110, while carrying out their Tasks. Other examples may include, for example, “Max. Approach Speed,” “Full Stop Distance,” “Allow Right of Way,” “Light Signaling Preference,” “Sound Signaling Preference,”. As a result, an AV 122 may make sure to approach and treat any Person 110 in its Environment 106 in the way that Person 110 wants to be approached and treated, even if the AV 122 may have trouble seeing (for example, in case of obstructed view) or recognizing such Person 110 (for example, when approaching the Person 110 from the back).

Using Machine Learning and AI methods, AVs 122 may learn over time from their interactions with individual People 110, and adjust their actions and behaviors accordingly, including, for example, how to acknowledge specific People's presence and how to approach, treat, and serve specific People 110.

Further, the Control System 102 may also proactively send messages and/or instructions to certain Mobile Equipment 132 that may be approaching an AV 122. These messages may cause the Mobile Equipment 132 to alter its actions and/or behaviors (for example, slowing down and/or changing course) to, for example, prevent a possible collision. The Person 110 may be walking or may be operating (i.e., driving) some kind of Mobile Equipment 132, such as a forklift or tugger or cleaning machine. In this case, the messages may be sent to a Human Machine Interface mounted on the equipment (e.g., Mobile Equipment) being operated by the Person 110 and/or to a mobile or wearable device carried or worn by the Person 110.

Some embodiments may include the Mobile Robot 122 which may adjust one or more actions and behaviors, including its travel path, speed, stop position and orientation, based on the actions and/or behaviors (incl. for example, the known or predicted travel path, speed, position, and/or orientation) of one or more People 110 and/or the actions and/or behaviors (incl. for example, the known or predicted travel path, speed, position, and/or orientation) of certain Mobile Equipment. The Mobile Equipment may be autonomous (i.e., another robot or some other type of autonomous vehicle) or the Mobile Equipment may be controlled by one or more People 110, whether directly or remotely. The (predicted) travel path, speed, position, and orientation of People 110 and Mobile Equipment within the AV's Environment 106 may be determined—and then used to control the AV's actions and behaviors—through the (accurate and real-time) data provided by an RTLS to the Control System 102. Or, through the data provided by an RTLS, combined with data from sensors such as Vision cameras, LiDAR, RADAR, and Sonar

The real-time data on actions and behaviors (incl. the known or predicted travel paths, speeds, positions, and/or orientations) of one or more People 110 and/or vehicles, incl. Mobile Equipment and Autonomous Vehicles 122 such as mobile robots, as provided through an RTLS, possibly combined with further sensor data from Vision cameras, LiDAR, RADAR, Sonar, or other electronic or electro mechanical device capable of generating empirical data quantifying a state within the Environment, may enable multiple AVs 122 to coordinate and collaborate with those People 110 and/or vehicles in real-time. One or more AVs 122 may for example, be following the lead from one or more People 110, or one or more other vehicles, which may be Mobile Equipment or Autonomous Vehicles 122, such as robots, and which may be controlled by one or more People 110, either “directly” or remotely. While being lead and controlled in such way, the AVs 122 involved may follow and respect the directions and control commands to the best of their ability, while taking into account certain circumstances related to their specific (individual) time and place, making for example, sure that they do not run into any Obstacles while trying to follow the directions and performing the commands provided.

Practical applications: An AV 122 following a Person 110 that is operating a forklift to take storage bins from racks in a warehouse, to then pick certain parts from these storage bins and place them into a bin or cart being carried or pulled by the AV 122. A cleaning robot following a Person 110 that is operating a cleaning machine, whereby the cleaning robot performs certain parts of the cleaning activity. (For example, cleaning around the edges that are hard or impossible to reach by the human-operated or autonomous larger cleaning machine. One or more robotic carts following a human-operated or autonomous tugger, without needing to be physically connected (“hitched”) together. A robot finding the best position and alignment to autonomously engage (and then pull or push) a cart.

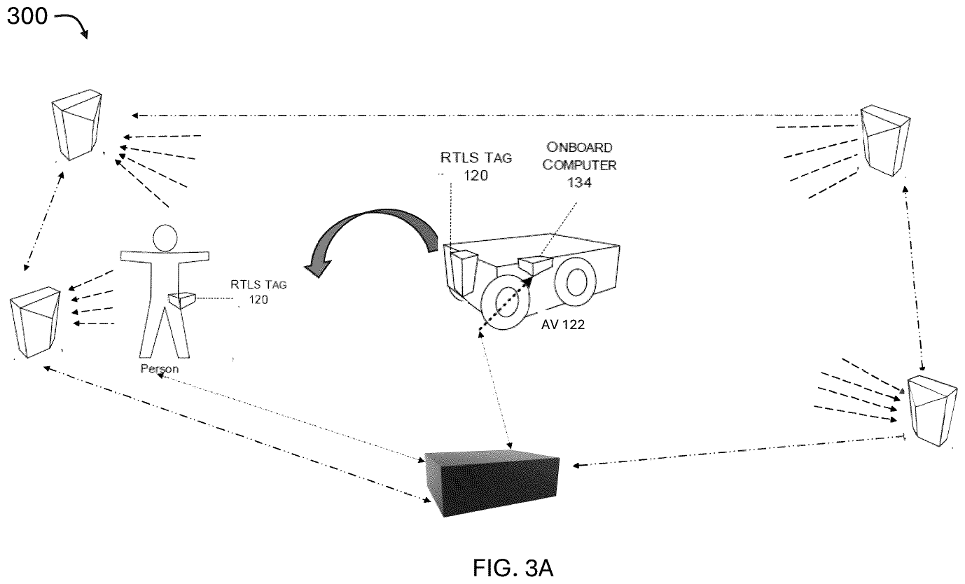

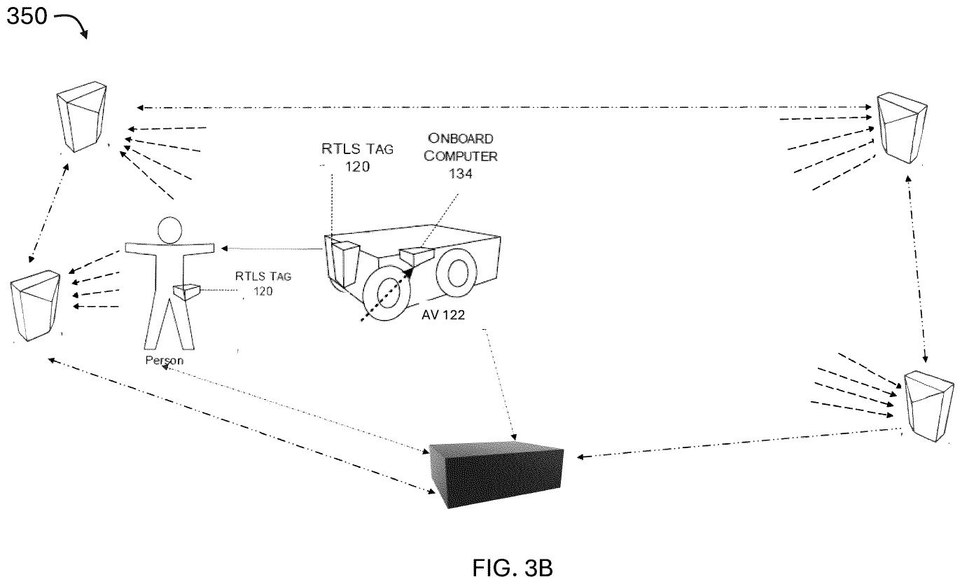

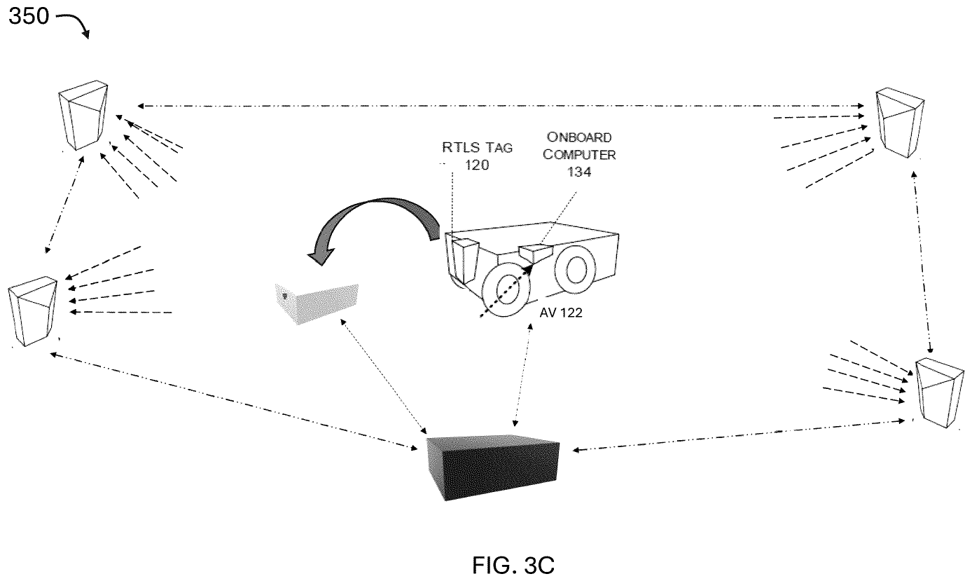

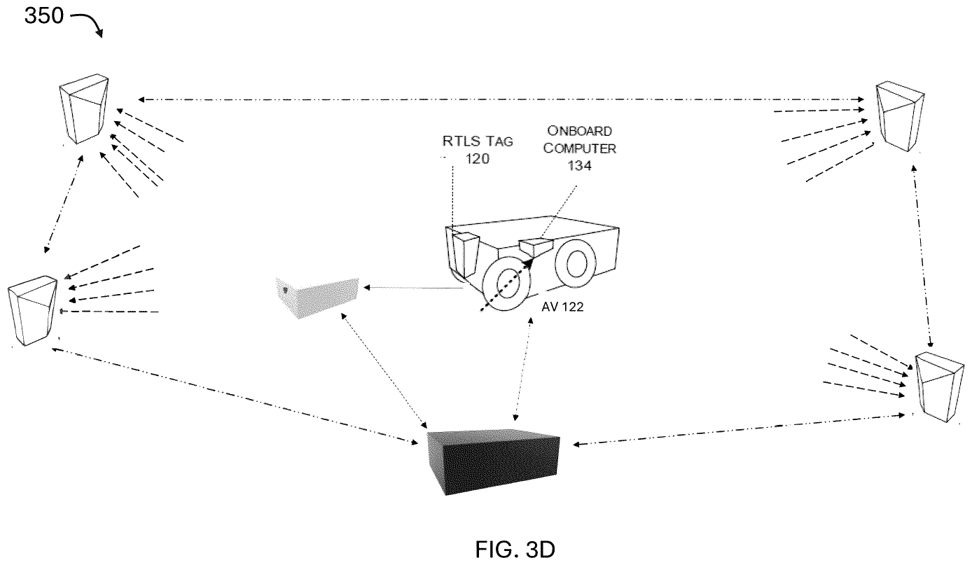

FIG. 3A-3B is a schematic representation of an exemplary environment comprising an exemplary Person 110 or Person 110 co-located with an RTLS Tag 120 which communicates with one or more People 110 co-located using the one or more RTLS Tags 120. The said RTLS Tag 120 co-located with the Person 110 may allow the RTLS to continuously monitor and track the Person's real-time location within the Environment 106. For instance, the real time location may include Location coordinates (xₕ,yₕ). The RTLS is responsible for accurately determining and updating the position of the RTLS Tag 120 as the Person 110 moves around, providing essential data to facilitate the AV's responsive and adaptive behaviors. The real-time location data (xₕ,yₕ). of the RTLS Tag 120 is shared with the Control System 102, to determine the most appropriate course of action for the AV 122. Specifically, the Control System 102 instructs the selected AV 122 to travel towards the real-time location of the Person 110. The primary objective is to reduce the distance between the AV's current location, denoted as (xᵣ,yᵣ), and the Person's location, denoted (xₚ,yₚ). The AV 122 continuously receives updates about the Person's position, allowing it to adjust its travel path dynamically as the Person 110 moves, and ensuring that it may effectively follow or approach the Person 110.

Further, FIG. 3B depicts that the movement of the AV 122 towards the Person 110 continues until the AV's Location (xᵣ,yᵣ), and the Person 110's location (xₚ,yₚ) are within a predetermined threshold distance, at which time it is deemed to have successfully located the Person 110, possibly triggering additional Tasks and/or behaviors programmed into the system. These subsequent actions may involve the AV 122 providing assistance, picking up or delivering Objects 112, or initiating a collaborative Task. The ability to precisely locate and approach a Person 110 enables the AV 122 to function more effectively in scenarios where close Human-AV interaction is required. As the AV 122 closes in on the Person 110, it may switch to other identification means, such as vision-based systems, to confirm the identity of the Person 110. Vision systems, such as cameras equipped with facial recognition or other image processing algorithms, may be used to positively identify the Person 110, ensuring that the AV 122 interacts with the correct Person 110. This additional layer of identification is particularly important in environments where multiple People 110 may be present, or where the AV 122 needs to perform personalized tasks based on the specific identity of the Person 110. By switching to vision-based identification, the AV 122 may accurately verify whether the approach is towards the correct Person 110 before proceeding with any further Tasks or interactions.

Some embodiments may include an AV 122 which first detects (and identifies) a Person 110, to then follow that Person 110, all enabled through an RTLS. The RTLS tracks the real-time location (xₚ,yₚ) of the Person's RTLS Tag and shares the Tag's real-time location (xₚ,yₚ) with the Control System 102. The Control System 102 directs a selected (capable and available) AV 122 to travel towards the real-time location (xₚ,yₚ) of the Person 110. (i.e., reducing the relative distance between the AV's location (xᵣ,yᵣ) and the Person's location (xₚ,yₚ). The AV 122 travels until the AV's Location (xᵣ,yᵣ) and the Person's Location (xₚ,yₚ) are within a certain threshold distance. The threshold distance, and other behaviors, may be configured and programmed. Once the AV 122 reaches the Person 110 it is following, it may pause in place as long as the Person 110 stays within the threshold distance, at which point the AV 122 will also allow the Person 110 to approach the AV 122 to, for example, place certain Objects 112 onto the AV 122 or take certain Objects 112 off the AV 122. While following the Person 110, the AV 122 can be made to respect the Approved Pathways configured/present/available in the Environment 106, instead of being able to follow more freely, without such restrictions. When traveling freely, without having to respect the Approved Pathways, the AV 122 may either follow as efficiently as possible (attempting to keep its relative distance as small as possible at all times) or follow (mimic) the exact Travel Path taken by the Person 110. Whether sticking to Approved Pathways or not, the AV 122 will typically follow the Person 110 or Object 112 in a “smart” manner, for example, trying to follow the Person 110 as efficiently as possible, while making sure not to run into anything while following.

FIG. 3C-3D is a schematic representation of an exemplary environment comprising an exemplary Object 112 co-located with an RTLS Tag 120 that can be detected by an AV 122. FIG. 3C is a schematic representation of an exemplary environment comprising an exemplary Object 112 co-located with an RTLS Tag 120, which communicates with one or more Anchors, in accordance with embodiments of the present disclosure. The Object 112 is co-located with an RTLS Tag 120. The said RTLS Tag 120 may allow the RTLS to continuously monitor and track the Object's real-time location (xₒ,yₒ) within the Environment 106, which may allow an AV 122 to find the Object 112. For instance, an AV 122 may find a specific Bin 112-2 or Cart 112-3 within a certain Environment 106, based on the RTLS Tag 120 associated with the Bin 112-2 or Cart 112-3. Upon finding a certain Object 112, based on the Object's associated RTLS Tag's Location, the AV 122 may validate that Object's 112 ID through further technologies and Sensor input, such as RFID or vision recognition. Further, the AV 122 may pick up the Object 112 autonomously and, for example, transport the Object 112 to a certain Destination Location (x_{d},y_{d}).

FIG. 3D depicts an AV 122 which follows a Person 110 (or, more generally, a VOP 110, 122) who is wearing one or more RTLS Tags 120, using the real-time location (xₚ,yₚ) of the Person's (or VOP's) associated RTLS Tag(s) 120, or a certain Object 112 (and, possibly more than 1 Object 112 at a time) co-located with one or more RTLS Tags 120, using the real-time location(s) (xₒ,yₒ) of the Object's associated one or more Tags, as provided by an RTLS. The AV 122 may follow any Object 112 that carries one or more RTLS Tags 120, which includes, but is not limited to a forklift, a Mobile Robot, or a Cart pulled by a Mobile Robot or tugger. Further, by having different AVs 122 follow different RTLS-tagged Objects 112 or VOPs 110, 122, including other AVs 122, AVs 122 may be made to “platoon”, i.e., AVs following other AVs, or AVs following other mobile Objects, such as AVs following forklifts, Tugger Trains, or carts pulled by Tugger Trains. Further, while following the VOP 110, 122 or Object 112, the AV 122 can be made to respect the Approved Pathways configured/present/available in the Environment 106, instead of being able to follow more freely, without such restrictions. When traveling freely, without having to respect the Approved Pathways, the AV 122 may either follow as efficiently as possible (attempting to keep its relative distance as small as possible at all times) or follow (mimic) the exact Travel Path taken by the VOP 110, 122 or Object 112. Whether sticking to Approved Pathways or not, the AV 122 will typically follow the VOP 110, 122 or Object 112 in a “smart” manner, for example, trying to follow the VOP 110, 122 or Object 112 as efficiently as possible, while making sure not to run into anything while following.

### Exemplary Operation:

In some embodiments, the VOP 110, 122 is collocated or otherwise equipped with one or more RTLS Tags 120, which are placed in or on the VOP 110, 122. The multiple RTLS Anchors 132A-N are positioned around and/or within the physical Environment 106 in which the VOP 110, 122 is operating. The RTLS Anchors 132A-N exchange RF signals with the RTLS Tags 120 and send resulting information to the Control System 102 over Ethernet or Wi-Fi connection or the like.

Using the information received from the RTLS Anchors 132-N, the Control System 102 determines the real-time Location of the RTLS Tags 120 that are co-located with the VOP 110, 122 and therefore the real-time Location of the VOP 110, 122 itself. Besides the real-time Location of the VOP 110, 122, the Control System 102 may also use further information received from the Anchors 132A-N to determine further details associated with the RTLS Tag120 (such as, for example, direction, speed, acceleration, and the like of the VOP 110, 122).

The Control System 102 provides the real-time Location (and in some embodiments, to her characteristics such as direction, speed, and acceleration.) of the VOP 110, 122 to the On-Board Computer 134 of VOP 110, 122, using a Wireless Datalink 136. In some embodiments, the On-Board Computer 134 of the VOP 110, 122 and/or the Control System 102 may also receive inputs from a number of other Sensors, such as, for example, one or more of. Inertial Measurement Units (IMUs), LiDAR sensors, ultrasonic sensors, wheel encoders, vision cameras, or other IoT devices or other electronic or electro mechanical device capable of generating empirical data quantifying a state within the Environment.

Specialized algorithms running on the Control System 102 and/or the On-Board Computer 134 or VOP 110, 122 may be used to implement certain logic that combines different sensorial inputs to achieve specific desired behaviors, such as navigating to a target Location, following a pre-defined route, slowing down in certain areas. In an example embodiment of the present disclosure, an open-source Robotic Operating System (ROS) may be used, but alternative libraries, drivers, and tools may be available or may be developed.

A Graphical User Interface (GUI) screen provides a user-friendly manner for People to interact with the Control System 102, allowing to impact and control the behavior of the VOP 110, 122 remotely. Voice controls may be used to interact with the Control System 102 and/or with the individual VOP 110, 122, either remotely or locally, in order to convey certain commands and affect certain actions and behaviors.

Wireless Datalink 136 refers to an apparatus and methods enabling communication of data in a wireless manner. Communication may be accomplished using technologies such as one or more of: Wi-Fi, Bluetooth, LoRa, UWB, or the like. In some embodiments, a Wireless Datalink 136 may be made operative to provide wireless communication of data and information between a Control System 102 and VOPs 110, 122 and Objects 112, and possibly other Control Systems involved. This data and information may include, for example, but not limited to, an estimated position, direction, speed, and acceleration of some, or all of the VOPs 110, 122 and Objects 112 involved. The data may also include, for example, conditions and rules that may be position related.

In various embodiments, the Control System 102 may be operative for all or some of the calculations referenced to calculate variables associated with the operation of the VOP 110, 122 in a physical Environment 106, such as, for example one or more of: locations, directions, speeds, and accelerations. Alternatively, the Control System 102 may gather and communicate this and any other relevant data to one or more VOPs 110, 122 and Objects 112 involved. While use of the Control System 102 to communicate real-time positioning data is preferred, it is also possible to calculate the position of a VOP 110, 122 by or on the VOP 110, 122 itself, in order to make the VOP 110, 122 operative to execute logic and to generate instructions to control the VOP 110, 122. This may be particularly useful for instructions governing quick, short-term, and/or short-distance travel.

Instead of a single Control System 102, there may be multiple Control Systems 102 that may exchange information between them.

A Control System 102 may include a processor in logical communication with a memory storing executable software that is executable upon command. For example, a Control System 102 may be implemented as a collection of on-premise computers, or be cloud-based, or a mix between on premise and cloud based.

The RTLS Anchors 132A-N are preferably implemented as a fixed infrastructure (one or more Anchors 132A-N mounted on walls and/or ceilings) but may also be mounted on, for example, mobile tripods, or even on one or more AVs 122, for more flexible or temporary deployments. The main consideration is to know the Location of the RTLS Anchors accurately enough at any point in time, in order to determine the Locations of any RTLS Tags within the same Environment of the RTLS Anchors.

In some embodiments, one or more RTLS Tags 120 may be made operative to fulfill the role of one or more RTLS Anchors 132A-N. The RTLS Anchors 132A-N may be networked to a (positioning) server in different ways, either wired or wireless. Each RTLS Anchor 132A-N may have a direct (for example Ethernet) link to the Control System 102, or certain Anchors 132A-N may be daisy-chained together. Some or all of the Anchors 132A-N may also communicate with the Control System 102 wirelessly, for example over a Wi-Fi connection.

The wireless datalink 136 needed to communicate the centrally available real-time location (and direction, speed, acceleration, and the like) does not necessarily need to be secure. However, a secure link is highly preferred, to reduce security risks.

Besides or instead of a Graphical User Interface (GUI) it is also possible to use alternative user interfaces, such as a command line interface, a voice interface, or a gesture interface.

Unlike VOPs 110, 122, People 110 are not controlled by On-board Computers 134, but any of the real-time location data available on the Control System 102 may be shared with People 110 as well, typically serving as guidance or directions, for example by sending it to their smart phone, smart watch, or tablet computer.

The VOPs 110, 122 referred to in this document include People 110, as well as any types of machines that have some method of propulsion and some method of steering, and that may be made to exhibit automated or autonomous behaviors, including but not limited to moving from one location to another within a certain physical space. The information obtained about the estimated position, direction, speed, and acceleration of any VOP 110, 122 may be shared not only with VOPs 110, 122 that are operating in the same physical space, but possibly also with VOPs 110, 122 that are operating in different physical spaces. This may allow for behavior replication or behavior duplication in different physical spaces.

The components and concepts described herein may be referred to by other nomenclature, such as, for example Anchors 132A-132N may be referred to as e.g., beacons, locators, or antennas; position and location may largely be used interchangeably; direction and orientation may be used interchangeably; speed and velocity may also be used interchangeably.

The VOP 110, 122 may be operative via executable software to know the real-time position of any other Objects 112 that also carry Tags 120, thereby enabling safe operation. The VOPs 110, 122 may modify their behavior depending on whether another nearby Object 112 is an AV 122, Mobile Equipment, or a Person 110 or multiple People 110, slowing down and/or keeping a further distance when approaching or being approached by People 110. The Person 110 wearing an RTLS Tag 120 may be notified whenever an AV 122, a Mobile Equipment, or possibly another Person 110 is approaching them, possibly on a collision course that may be obstructed from view.

Specific areas may be “geofenced,” on or via a Control System 102. Then, specific parameters such as maximum allowed speed, minimum distance, and the like can be defined for each Geofenced Area, so that a VOP 110, 122, knowing its real-time position relative to the Geofenced Areas thanks to e.g., an RTLS, may modify its behavior based on the area it is navigating through or towards (e.g., slow down or avoid altogether).

A VOP 110, 122 may be provided with a specific, fixed Location (e.g., a Location coordinate or a Location name) in the Environment 106 where it is operating, for the VOP 110, 122 to autonomously navigate towards that Location. Or, a VOP 110, 122 may also be given the Tag ID (or some other unique identification, such as a universally unique identifier or name) of a RTLS Tag or a mobile Object 112 being tracked by the RTLS, for the VOP 110, 122 to navigate towards (and find or meet up with) that RTLS Tag or mobile Object 112—all while moving around safely and possibly following Virtual Approved Pathways 402. This capability makes it possible for VOPs 110, 122 to find and retrieve mobile Carts that are not always in a same exact physical location, and/or bring certain materials, equipment or tools to People 110 that need these materials, equipment, or tools, but who may be moving around the Environment 106. The VOP 110, 122 may be requested to come, go to, or find a specific Object 112 or Person 110, anywhere within the physical space covered by the Anchors 132A-N.

In an example, specific routes for the VOP 110, 122 to follow may be established by defining a set of digital coordinates, also called waypoints. These waypoints may be defined in a number of different ways. They may be established for example, by physically moving an RTLS Tag 120 along the desired route and recording the Tag's position along the way. The waypoints may also be established on the Control System 102, either through a terminal using some (graphical) user interface or using a wearable device such as a smart phone or tablet, by tracing or drawing them on a graphical representation (such as a floor plan) of the Environment 106 where the VOP 110, 122 is or will be operating. Virtual Routes may be established, managed, and updated on the Control System 102 and shared with any VOPs 110, 122 involved using the Wireless Datalink 136 or some other wireless datalink.

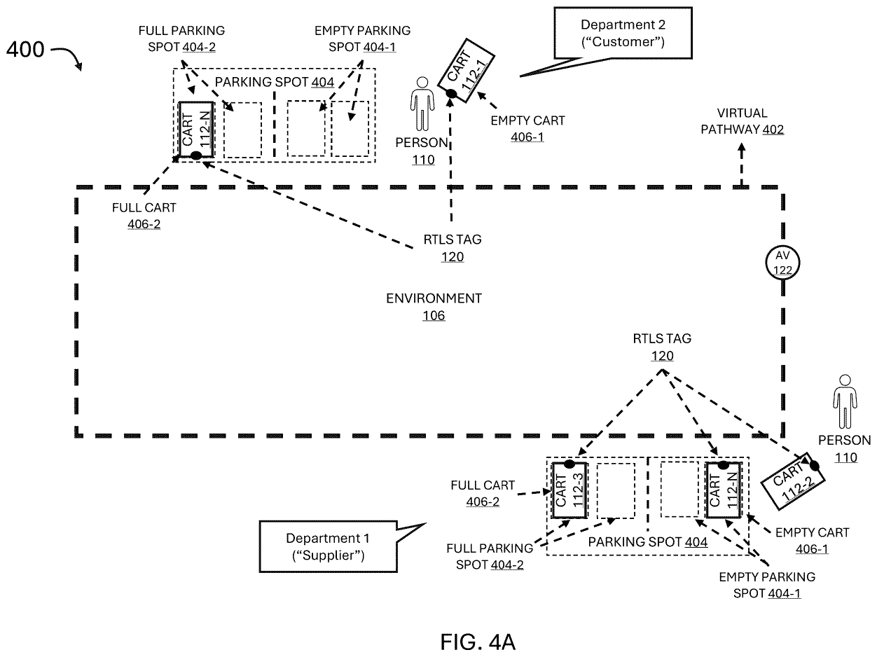

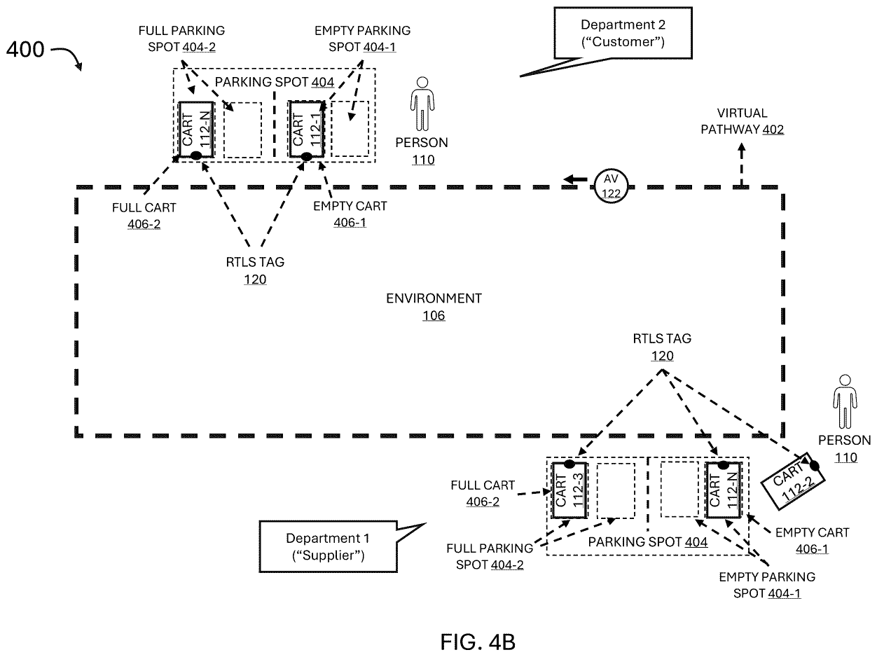

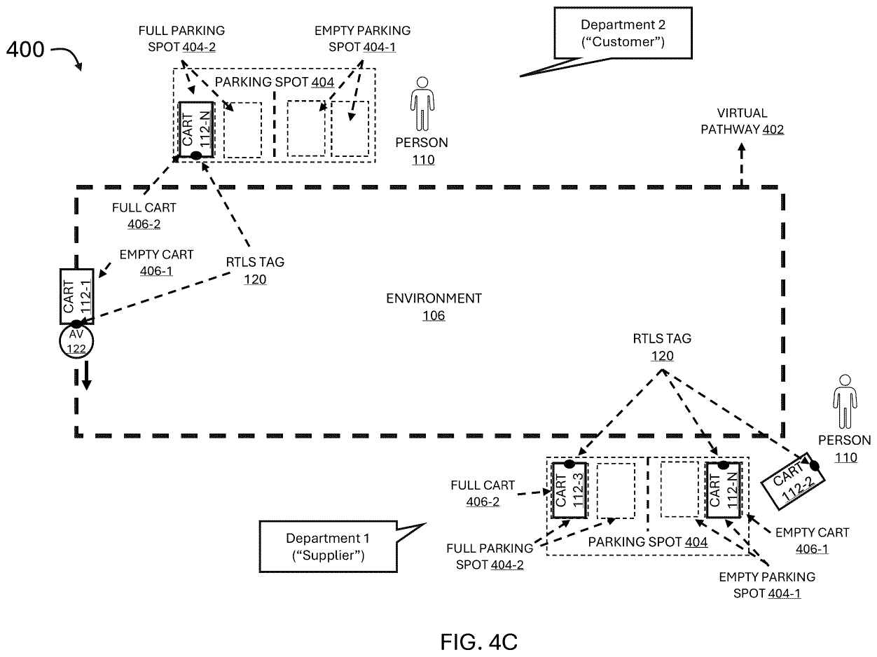

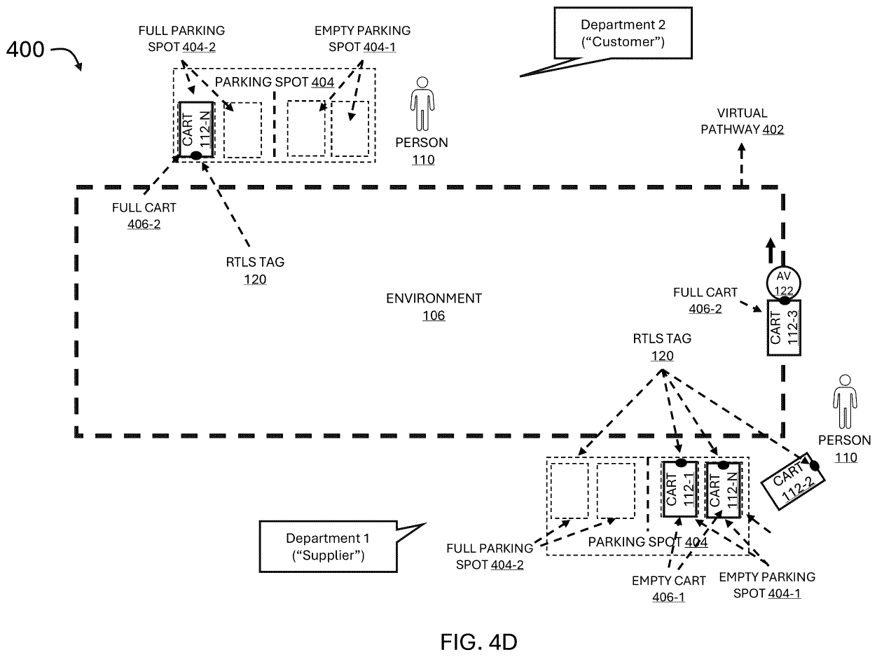

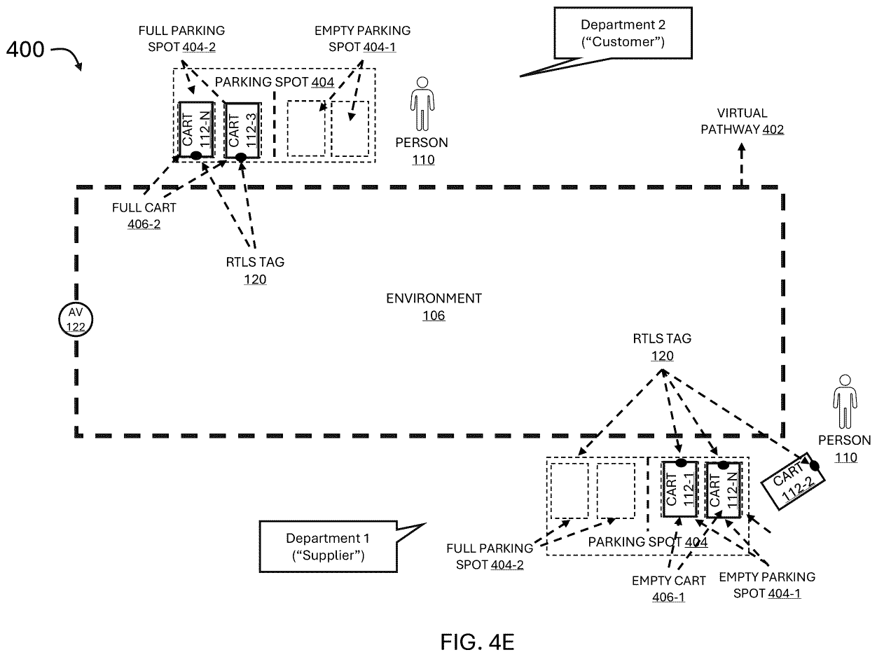

FIGS. 4A-4B are schematic drawing of an exemplary representations of Virtual Pathways for one or multiple VOPs 110, 122 and AV 122 interaction in an Environment 106, in accordance with embodiments of the present disclosure. According to some embodiments of the present invention (and as illustrated) a two-dimensional surface layout of representing a physical Environment 106 and virtual pathways 402 that the VOP 110, 122 may travel according to a series of current position designations and destination positions is depicted. Other embodiments may include a three dimensional or perspective view in a user interface. All of the VOP 110, 122, for instance, Carts 112-1, 112-2, 112-3, 112-N are equipped with the RTLS Tag 120. One or more parking spots 404 may be Geofenced Zones in the Environment 106, where the parking spots are reserved for Carts 112-1, 112-2, 112-3, 112-N. In some embodiments, parking spots 404 may characterized according to a current status, such as, for example, an Empty Parking Spot 404-1, a Full Parking Spot 404-2, other designation. The Cart 112 may include one or more statuses, which include an Empty Cart 406-1, a Full Cart 406-2. The Empty Carts 406-1 are put and kept in the Empty Parking Spot 404-1. The Full Carts 406-2 are kept in the Full Parking Spots 404-2. The Parking Spot is considered empty/available when the control system does not detect a tagged cart inside of the parking spot. In another instance, when the Cart 112 is placed in “Full” Parking Spot 404-2 at department 1, also available “Full” Parking Spot at department 2, then the Mobile Robot 122 may be triggered to transfer the Cart 112 to the “Empty” Parking Spot at department 2.

The Full Carts, designated as 406-2, are stored in Full Parking Spots, labeled 404-2. These parking spots are monitored by a Control System 102 that determines availability, using e.g., Geofenced Zones. The parking spot is marked as empty or available when no tagged carts are detected within it by the system. The monitoring ensures efficient management of cart storage. For instance, when Cart 112 is placed in a Full Parking Spot in department 1 and another available Full Parking Spot in department 2, the system recognizes this setup. It then triggers the AV 122 to initiate a transfer task. The AV 122 may be activated to execute specific tasks or exhibit particular behaviors by pressing one or more buttons on an RTLS (Real-Time Location System) tag. The AV's response may vary based on how the buttons are pressed-such as a short or long press, or a sequence like “short-short” or “long-long.” Different combinations of button presses may also trigger distinct tasks or behaviors in the robot. Furthermore, the AV's behavior may be influenced by its location and the location of the RTLS tag 120 at the time of the button press. For instance, if the AV 122 is within a Specific Geofenced Area 402 or at a particular relative position to the RTLS Tag 120, it might perform a different task or execute the same task in a different manner. The Control System 102 enables context-aware interactions, where the AV 122 adapts its actions based on both the input from the RTLS Tag buttons and its spatial relationship to the Tag RTLS 120, enabling more dynamic and responsive automation in various environments.

The said automation allows the AV 122 to move the Carts 112 between departments as needed, streamlining operational workflows. The ability of the Control System 102 to detect the presence or absence of Carts 112 and coordinate with AVs 122, such as mobile robots, enhances the efficiency of material handling and reduces manual intervention. By leveraging such automated triggers, the organization may ensure smooth and timely movement of tasks, improving overall productivity and operational flow.

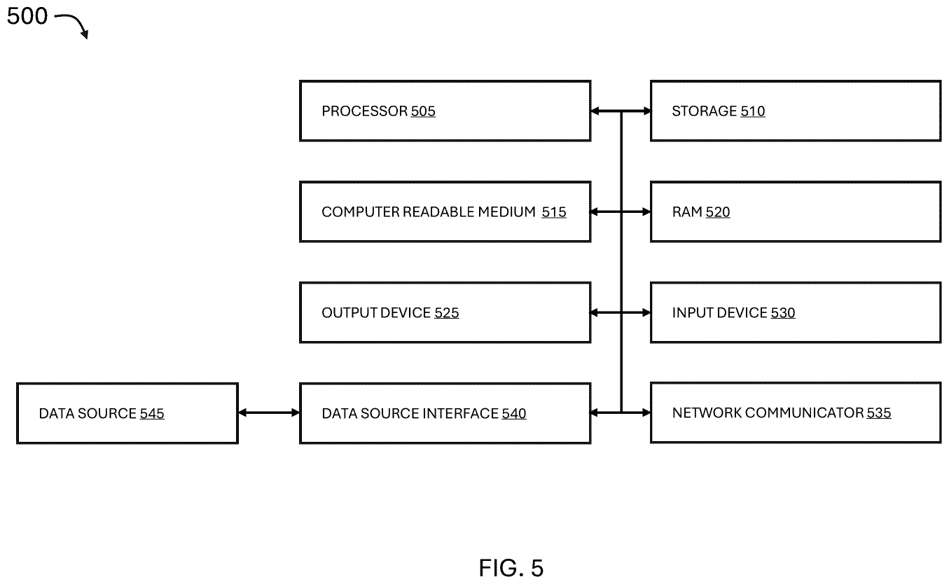

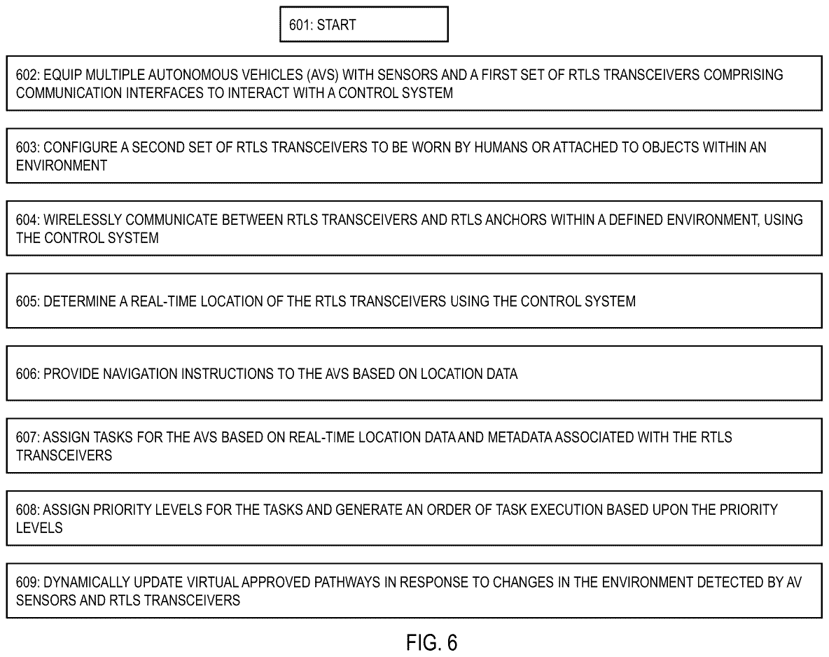

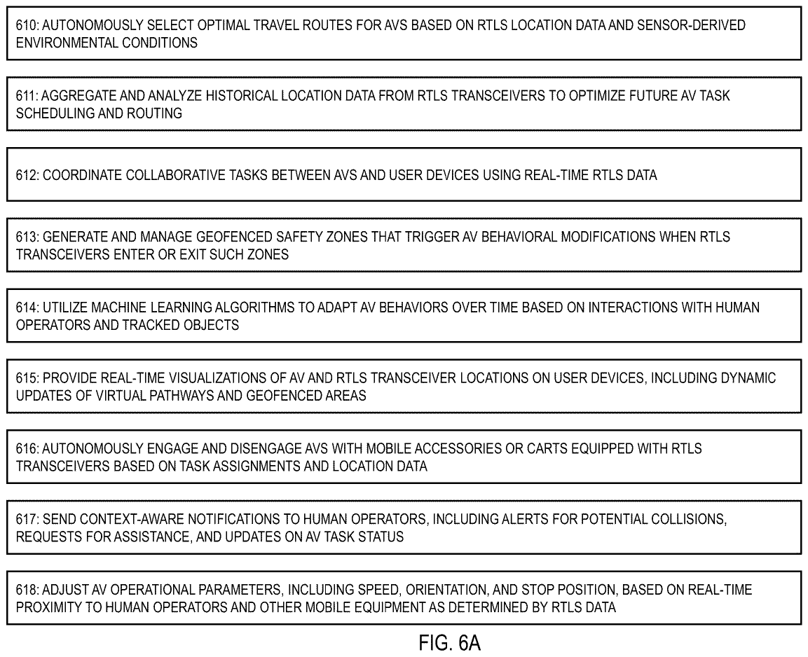

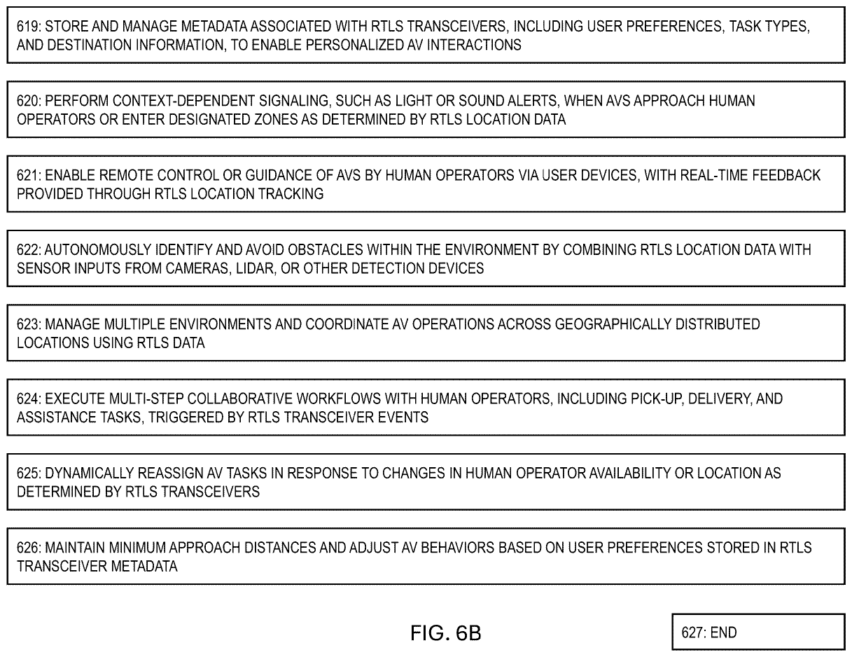

FIG. 5 is an exemplary block diagram representation of a Control System 102, depicting various hardware components, capable of controlling or guiding the AVs 122 in an Environment 106, in accordance with embodiments of the present disclosure. The Computer System 500 may be part of or any one of the Control Systems 102, the VOP 110, 122, the Computing Devices 124, and the RTLS Anchors 132A-N, or the like to perform the functions and features described herein. The Computer System 500 may include, among other things, an Interconnect 510, a Processor 505, a Storage 510, a Computer Readable Medium 515, a RAM 520, an Output Device 525, an Input Device 530, a Data Source 545, a Data Source Interface 540, and a Network Communicator 535.

The interconnect (not shown in FIG. 5) may interconnect various subsystems, elements, and/or components of the Computer System 500. As shown, the interconnect may be an abstraction that may represent any one or more separate physical buses, point-to-point connections, or both, connected by appropriate bridges, adapters, or control systems. In some examples, the interconnect may include a system bus, a peripheral component interconnect (PCI) bus or PCI-Express bus, a Hyper Transport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect may allow data communication between the processor 505 and system memory, which may include read-only memory (ROM) or flash memory (neither shown), and random-access memory (RAM) 520. It should be appreciated that the RAM 520 may be the main memory into which an operating system and various application programs may be loaded. The ROM or flash memory may contain, among other code, the Basic Input-Output system (BIOS) which controls basic hardware operation such as the interaction with one or more peripheral components.

The Processor 505 may be the central processing unit (CPU) of the computing device and may control the overall operation of the computing device. In some examples, the Processor 505 may accomplish this by executing software or firmware stored in system memory or other data via the Storage 510. The Processor 505 may be, or may include, one or more programmable general-purpose or special-purpose microprocessors, digital signal processors (DSPs), programmable control systems, application specific integrated circuits (ASICs), programmable logic device (PLDs), trust platform modules (TPMs), field-programmable gate arrays (FPGAs), other processing circuits, or a combination of these and other devices.

The multimedia adapter (not shown in FIG. 5) may connect to various multimedia elements or peripherals. These may include a device associated with visual (for example video card or display), audio (for example sound card or speakers), and/or various input/output interfaces (for example mouse, keyboard, touchscreen).

The Network Communicator 535 may provide the computing device with an ability to communicate with a variety of remove devices over a network and may include, for example, an Ethernet adapter, a Fiber Channel adapter, and/or another wired- or wireless-enabled adapter. The Network Communicator 535 may provide a direct or indirect connection from one network element to another and facilitate communication between various network elements.

The Storage 510 may connect to a standard computer-readable medium for storage and/or retrieval of information, such as a fixed disk drive (internal or external).

Many other devices, components, elements, or subsystems (not shown) may be connected in a similar manner to the interconnect or via a network. Code or computer-readable instructions to implement the dynamic approaches for payment gateway selection and payment transaction processing of the systems and methods may be stored in computer-readable storage media such as one or more of system memory or other storage. Code or computer-readable instructions to implement the dynamic approaches for payment gateway selection and payment transaction processing of the systems and methods may also be received via one or more interfaces and stored in memory.

The Control System 102 may be included in one or more of: a wireless tablet or handheld device, a server, a rack mounted processor unit. The Control System 102 may be included in one or more of the apparatuses described above, such as a Server, and a Network Access Device.

In some examples, the Processor 505 may be supplemented with a specialized processor for AI related processing. The Processor 505 may also cause the communication device to transmit information, including, in some instances, control commands to operate apparatus to implement the processes described above. The Processor 505 and Storage Devices 510 may access an AI training component (not shown) and database, as needed, which may also include storage of machine learned models.

In some embodiments, the present method may include initializing, by a Processor 505, one or more Anchors 132 and an AV 122 to detect RTLS Tags 120 in the Environment 106. The one or more Anchors 132 are strategically placed throughout the Environment 106 to create a coordinate system for tracking. The one or more Anchors 132 are calibrated to ensure accurate signal transmission and reception. The Mobile Robot 122 is configured to benefit from the RTLS Tags 120 within the Environment 106, using the signals from the one or more Anchors 132 to triangulate the position of any detected RTLS Tags 120.

The present method may include identifying, by a Processor 505, the RTLS Tags 120 and approaches of at least one of Person 110 and Object 112 with the RTLS Tag 120. The Mobile Robot 122 identifies RTLS Tags 120 within an Environment 106 by scanning for active signals. Once an RTLS Tag 120 is detected, the Mobile Robot 122 determines whether the RTLS Tag 120 may be associated with the at least one of the Persons 110 and the Object 112.

Further, the present method may include applying one or more recognition techniques, beyond using RTLS Tags 120, to confirm the identity of the at least one of Person 110 and Object 112. For example, once an AV 122 has found a tagged VOP 110, 122 or Object 112, based on the tracked Location of the VOP or Object's RTLS Tag, the AV 122 may validate the VOP or Object's identity through additional methods, such as RFID or vision recognition, before interacting further with the VOP 110, 122 or Object 112.

Furthermore, the present method may include picking up, by an AV 122, autonomously, the at least one of Person 110 and Object 112, and moving the Person/People and/or Object(s) to a Destination Location.

The present system enables the automation of useful activities and workflows without requiring the traditional type of “integration” that is typically needed to get enterprise automation systems to work and provide value. Simply placing RTLS Tags 120, or Objects (such as boxes, bins, trays, crates, or carts) that are carrying RTLS Tags 120 in certain Locations, may instantly trigger useful Tasks to be performed by AVs 122. Simply pushing an RTLS Tag button, in certain ways, may enable a Person 110 to request an AV 122 to perform a certain Task in a certain way, enabling People 110 to collaborate with—and be supported by—AVs 122 in very quick and intuitive ways, without almost any training at all. The present system enables the AVs 122 to perform useful on-demand work, whenever and wherever something needs to be performed, rather than only being able to perform routine tasks on a pre-determined schedule and along predetermined and very limited routes. Objects 112 and People 110 no longer need to be in predetermined, fixed locations for AVs 122 to be able to find and interact with them. Instead, AVs 122 are able to find and engage with Objects 112 and People 110 wherever they are within the AV's Environment 106.

The present system provides a simple and powerful way for People 110 to interact with AVs 122, such as Mobile Robots, and enable the AVs 122 to perform useful tasks, especially unplanned/unscheduled “on-demand” or “ad-hoc” tasks, whereby AVs 122 are being tasked with responding to requests for support by People 110, whenever and wherever that support is needed.

The description of both preferred and alternative examples though thorough, are exemplary only, and variations, modifications, and alterations may be apparent to those skilled in the art. It is therefore to be understood that the examples do not limit the broadness of the aspects of the underlying disclosure as defined by the claims.

The embodiments herein and the various features and advantageous details thereof are explained with reference to the non-limiting embodiments illustrated in the accompanying drawings and detailed in the description. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

### Glossary

“Administrator” or “Admin” or “Admin.” as used herein shall mean a person or entity defining the rules to be respected and/or setting the objectives to be achieved, this includes drawing, recording, or otherwise defining (Virtual) (Approved) Pathways or (Virtual) (Approved) Pathway Sections.

“Asset” as used herein shall mean an Object or VOP within an Environment. An Asset may be (re)presented as a Virtual Element, by a computer system such as a Control System, on a digital representation of an Environment, such as a Map or Floor Plan or 3D rendering. An Asset may have certain Properties and/or Rules associated with it.

“Autonomous Vehicle” or “Automated Vehicle” or “AV” as used herein shall mean a vehicle that is at least partially autonomous, i.e., able to navigate, travel, and operate within a certain Environment in a partially or fully autonomous fashion. A Robot is an example of an Autonomous Vehicle, and some examples of Robots include automated guided vehicles (AGVs), autonomous mobile robots (AMRs), humanoid robots, and drones. For our purposes, “automated” and “autonomous” can be used interchangeably.

“Capability” as used herein shall mean the ability to perform a certain task or activity, based on for example competency, physical abilities, and/or Environmental Conditions.

“Capacity” as used herein shall mean the ability to perform a certain task or activity, based on the time available.

“Cart” or “Cart Object” as used herein shall mean an Object that may be used to hold and transport other Objects within an Environment. A Cart may be (re)presented as a Virtual Element, by a computer system such as a Control System, on a digital representation of an Environment, such as a Map or Floor Plan or 3D rendering. A Cart may have certain Properties and/or Rules associated with it.

“Cart Property” as used herein shall mean a property that applies to a Cart.

“Characteristic” as used herein shall mean a distinguishing feature or quality that defines and differentiates VAPs, VOPs, and/or Assets.

“Computing Device” as used herein shall mean a computer or a computation capable device for performing some computation within itself. Examples may include a positioning server, a (local) control system, and any mobile, tablet, PC, wearable device, or other electronic devices.

“Control System” as used herein shall mean a computer system that receives, stores and/or accesses certain data from a multitude of sources and that runs certain algorithms to process and interpret such data, including but not limited to data provided by one or more RTLS and/or VOPs operating within a certain Environment or set of Environments, and/or data captured through certain (other) Sensors present in the one or more Environments, to help control or guide the actions and/or behaviors of one or more VOPs, such as mobile robots, e.g. related to creating and managing Tasks (e.g., functioning as a “Task Management System”), determining feasible or optimal travel trajectories, and coordinating the activities of one or more AVs (e.g., functioning as a “Fleet Management System”). A Control System may either be carried by one or more VOPs, sometimes referred to as “on-board,” and/or maintained in the Environment, sometimes called a “local server”, and/or maintained remotely such as in a private or public Cloud, sometimes called a “Cloud server.”

“Destination” or “Destination Point” or “Destination Position” or “Destination Location” as used herein shall mean the target Location of a VOP or Object, e.g., the Location where a certain Object or Person needs to get transferred to. This could be a Fixed Location, often referred to as “Fixed Destination” or a “Fixed Destination Location”, or a Dynamic Location, often referred to as a “Dynamic Destination” or “Dynamic Destination Location”. A Destination may be (re)presented as a Virtual Element, by a computer system such as a Control System, on a digital representation of an Environment, such as a Map or Floor Plan or 3D rendering. A Destination may have certain Properties and/or Rules associated with it.

“Deviation” as used herein refers to the maximum distance a VOP is allowed to deviate from a VAP to, for example, optimize its travel trajectory.

“Environment” or “Operating Environment” as used herein shall mean the defined/delimited/demarcated physical environment, in 2D or 3D space, within which a VOP operates and navigates to perform certain Tasks (“work”) and achieve certain Objectives. An Environment may have certain Properties and/or Rules associated with it.

“Environmental Characteristics” as used herein shall mean certain characteristics of the Environment which typically remain unchanged over time, for example location and dimensions of aisleways. These Environmental Characteristics may possibly be observed and measured by the VOPs that are operating within the Environment.

“Environmental Conditions” as used herein shall mean certain conditions or circumstances within the Environment, which typically evolve over time, as observed and measured by the VOPs operating within the Environment, or as observed and measured by certain Sensors within the Environment. The current location of one or more VOPs and/or Objects within the Environment may be considered part of the Environmental Conditions.

“Existing VAP” or “Original VAP” as used herein shall mean a VAP that is of a more “predefined” or more “static” nature, representing some or all the possible Routes a Control System may select from to establish one or more Trajectories for one or more VOPs, as opposed to a “Temporary VAP”, which is of a more “temporary” nature, to for example help address some temporary need.

“Geofenced Zone” or “Geofenced Area” as used herein shall mean a Zone or Area that is identified and demarcated virtually (or digitally) in some software system. Often, a geofenced Zone or Area corresponds with a real-world Zone or Area, in which case the geofenced Zone or Area may be considered part of a “digital twin” of the real-world Environment.

“ID Tag” as used herein shall mean a tag, such as an RTLS Tag, which identifies a certain Object, such as a certain part, job, work order, cart, bin, etc., that, for example, needs to be transferred from one location to another.

“Interaction Module” or “RTLS based Interaction Module” as used herein shall mean a module, as part of a Control System, which is responsible for monitoring and controlling (or guiding, in case of People) the actions and behaviors of one or more Vehicles or Persons (VOPs) while they are performing a certain Task. In case of an Autonomous Vehicle, the RTLS interaction Module is typically able to directly control the actions and behaviors of the Autonomous Vehicle, whereas in case of a Person, the RTLS interaction Module will typically guide the Person, and possibly enable the Person to, for example, perform a task in collaboration with a Robot through feedback and instructions communicated by and to the Person through a User Device.

“Load” or “Load Object” as used herein shall mean one or more Objects that need to be, or are being, relocated (transported) within an Environment. Boxes, bins, and crates are examples of Loads. A Cart, whether empty, partially filled, or full, is another example of a Load. Such Cart may itself carry one or more Objects, which each represent a separate Load by themselves. A Load may be (re)presented as a Virtual Element, by a computer system such as a Control System, on a digital representation of an Environment, such as a Map or Floor Plan or 3D rendering. A Load may have certain Properties and/or Rules associated with it.

“Location” as used herein shall mean a specific (physical) position or location (“place”) within the Environment, as defined by an associated set of 2D or 3D coordinates. Locations can either be fixed or dynamic, referred to respectively as “Fixed Locations” or “Dynamic Locations”. A Fixed Location is defined by fixed (or “static” or “immobile” or “unchanging”) 2D or 3D coordinates, whereas a Dynamic Location is defined by “dynamic”, i.e., changing over time, possibly “live” or “real-time”, 2D or 3D coordinates, as typically provided by a Real-Time Location System.

“Mobile Equipment” as used herein shall mean equipment that is mobile and can change or be made to change its location within some Environment. Mobile equipment may be autonomous (i.e., a Mobile Robot or some other type of Autonomous Vehicle) or the mobile equipment may be controlled by one or more Human Operators, whether directly or remotely.

“Mobile Robot” or “Bot” as used herein shall mean a programmable device, consisting of mechanical and electronic components, and equipped with Sensors and algorithms that enable it to perform certain Tasks autonomously or semi-autonomously, including traveling, navigating, and/or operating (semi)autonomously within a certain (2D and/or 3D) Environment. This includes responding to environmental inputs or pre-defined programming criteria. Robots typically support and interact with Human Operators and may possess mobility, such as in the case of Automated Guided Vehicles and Autonomous Mobile Robots, flight capabilities (as with drones), or anthropomorphic features (as in humanoid robots). A Robot may be represented as a Virtual Element, by a computer system such as a Control System, on a digital representation of an Environment, such as a Map or Floor Plan or 3D rendering. A Robot may have certain Properties and/or Rules associated with it. A Robot is a type of Automated Vehicle.

“Navigate” as used herein shall mean to decide how to Travel, and/or to actually Travel, between various locations within an Environment.

“Navigation Plan” as used herein shall mean a possible travel route, determined by a Control System, to enable a certain VOP to perform a certain Task within a certain Environment. A Control System typically determines and evaluates multiple Navigation Plans, across multiple VOPs and VAPs, in order to select the Optimal Navigation Plan and assign it to the best-positioned (“optimal”) VOP, in view of all the relevant Properties, Operational Rules, and Objectives involved. Besides a specific travel route, or Trajectory, a Navigation Plan also includes all additional planned parameters, for example, the target minimum, average, and/or maximum speeds at which a VOP is directed to travel along the chosen route, as determined by all the Properties and Rules associated with the Task, and any Loads and/or Carts involved, as well as any VAPs or VAP Sections and Zones and Stations, or other Waypoints, and the like involved along the planned route during the VOPs performance of the Task.

“Notification” or “Advance Notification” as used herein shall mean a notification sent by an AV or Control System, to one or more Human Operators or groups of Human Operators. Such Notifications can take the form of (among others) “(Shared) Information”, “Alerts”, or “Requests for Assistance”, and will typically be sent to and shown (as e.g. text messages and/or pop-up notifications) on User Devices, e.g., the mobile phones or tablet computers or smart watches or smart glasses (e.g., mobile devices and possibly “wearables”) carried or worn by those Human Operators, and/or to certain tablet computers or other computer stations that are present e.g. in the Mobile Equipment or at workstations used by those Human Operators.

“Object” as used herein shall mean a physical item within an Environment that typically can move or be moved. Some examples of Objects include parts, tools, fixtures, carts, pallets, boxes, bins, trays, folders, pallet jacks, forklifts, tugger trains, scissor lifts, boom lifts, automated guided vehicles, autonomous mobile robots, drones, VOPs, Automated Vehicles or People, such as mobile robots, Obstacles, Sensors, Computing systems, Communication interfaces, RTLS tags, RTLS anchors, Network devices or the like, may be considered to be Objects. An Object may be (re)presented as a Virtual Element, by a computer system such as a Control System, on a digital representation of an Environment, such as a Map or Floor Plan or 3D rendering. An Object may have certain Properties and/or Rules associated with it.

“Objective” or “Objective Set” as used herein shall mean one or more specific objectives to be achieved by a Person, Autonomous Vehicle, or Robot (“VOP”) while performing, and possibly collaborating on, a particular Task, or a set of consecutive or parallel Tasks. For example, transferring some Object from some Origin to some Destination “safely,” “on time,” along the “shortest route” or according to the “quickest travel time,” or other descriptor.

“Obstacle” as used herein shall mean an Object that may prevent a VOP from navigating and traveling freely, possibly causing an adjustment in Trajectory, for example, through some avoidance maneuver. An Obstacle may be (re)presented as a Virtual Element, by a computer system such as a Control System, on a digital representation of an Environment, such as a Map or Floor Plan or 3D rendering. An Obstacle may have certain Properties and/or Rules associated with it.

“Obstacle Avoidance Distance” as used herein shall refer to the maximum distance a VOP is allowed to deviate from a VAP while performing an obstacle avoidance maneuver (i.e., a special case of Deviation).

“Operate,” as used herein, shall mean to perform certain Tasks or activities (“work”). For example, VOPs perform certain tasks within the Environment.

“Operational Rules” as used herein shall mean the entire collection of Rules that an VOP should abide by, based on all the Rules that are applicable to the VOP along the Trajectory traveled by the VOP while performing a Task or set of Tasks, for example, including any VAP Rules, Zone Rules, and/or Station Rules that apply to the VOP while it is traveling to and/or through certain Stations and/or Zones, along certain VAPs. Operational Rules typically help determine Navigation Plans.

“Optimal Navigation Plan” as used herein shall mean the specific Navigation Plan chosen by a Control System and assigned to a selected VOP to perform a certain Task.

“Optimal Trajectory” as used herein shall mean the specific Trajectory chosen by a Control System for a selected VOP to perform a certain Task.

“Origin” or “Origin Location” as used herein shall mean the location where a certain Object or Person needs to get picked up from; this could be a Fixed Location or a Dynamic Location (“Fixed Origin” or “Fixed Origin Location” vs. “Dynamic Origin” or “Dynamic Origin Location”).

“Path Point” as used herein shall mean a Location within the Environment, used to define a Pathway or a Pathway Section. Typically, the start and finish of a Pathway, or a Pathway Section, as well as any inflection points along such Pathway, may be considered Path Points. A Path Point may be (re)presented as a Virtual Element, by a computer system such as a Control System, on a digital representation of an Environment, such as a Map or Floor Plan or 3D rendering. A Path Point may have certain Properties and/or Rules associated with it.

“Pathway” or “Path” as used herein shall mean a designated path or route that may be used by VOPs to navigate through an Environment while performing certain tasks. A Pathway may be represented as a Virtual Element, by a computer system such as a Control System, on a digital representation of an Environment, such as a Map or Floor Plan or 3D rendering. A Pathway may have certain Properties and/or Rules associated with it.

“Person” or “Human” or “Operator” or “Human Operator” as used herein shall mean a person (plural: persons or people) who performs certain activities within an Environment, and while performing such activities, at times may encounter or interact with a VOP. An Operator may be (re)presented as a Virtual Element, by a computer system such as a Control System, on a digital representation of an Environment, such as a Map or Floor Plan or 3D rendering. An Operator may have certain Properties and/or Rules associated with them.

“Pose” as used herein shall mean the combination of Position and Orientation.

“Position” as used herein shall mean the Location of a VOP or Object, including for example, an Obstacle.

“Positioning Server” or “Server” as used herein shall mean a computer that receives data from one or more sensors, such as RTLS Anchors and/or RTLS Tags, which are present within a certain Environment and uses that data to determine the (real-time) location of certain Objects, such as RTLS Tags, which are active within that Environment. It is possible for a Positioning Server to receive (additional) data from other sources, possibly generated through other Sensors, to then use that data in the determination of the (real-time) location of RTLS Tags and/or the VOPs or Objects that those Tags are associated with (e.g., worn by, carried by, mounted to, integrated in, etc.) One example of such data would be IMU or accelerometer data provided by the RTLS Tags. Another example may be wheel odometry data provided by an AV. Another example may be vision odometry data provided by a camera system. Another example may be positioning data provided through LiDAR, RADAR, SONAR, ultrasonic sensors, camera sensors with or without Vision AI capabilities, etc.

“Property” as used herein shall mean a Capability, Capacity, Characteristic, Requirement, or other attribute.

“Property Matching” as used herein shall mean to identify Assets, for example VOPs and VAPs, for which certain Properties match, for example certain VOP Properties match certain VAP Properties, enabling certain activities and/or driving certain behaviors.

“Real-Time Location System” or “Real-Time Locating System,” or “RTLS” as used herein, shall mean a technology used to automatically track the location and movement of Objects, including, for example, Autonomous Vehicles such as Mobile Robots, or People (together at times referred to in short as “VOPs”), often in real time, within a defined 2D or 3D environment. An RTLS typically uses “Tags” (also called, for example, “trackers,” or “labels”) attached to the Objects or worn by the People being tracked, and a network of “Anchors” (also referred to as for example, “antennas,” “receivers,” “readers,” or “beacons”) mounted in the Environment, typically in fixed—or at least known—locations. Anchors and Tags exchange wireless (for example, RF) signals (using, for example, UWB, BLE, RFID, Wi-Fi, LoRa, 5G, GPS, GPS/RTK, RADAR, or any other suitable technology) to determine the positions and movements of the Tags, thereby determining the positions and movements of the Objects or People that the Tags are attached to or worn by. In certain cases, User Devices, including mobile devices, such as a phones or tablet computers, and wearable devices, such as a smart glasses, may function as RTLS Tags, i.e., send out certain RF signals to allow for the RTLS to determine and track their position within the Environment. Instead of or in addition to using RF signaling, the RTLS may also use other sensors, such as cameras, LiDAR, RADAR, Sonar, ultrasonic sensors, or other electronic or electro mechanical device capable of generating empirical data quantifying a state present in the Environment, including sensors mounted on some or all of the VOPs. The information is typically relayed to a Controller and/or some other software platform that processes the data and displays the locations of the Objects on a map of the Environment, possibly in real time.

“Return Tag” as used herein shall mean a Tag that alerts or triggers and enables a VOP, such as a mobile robot, to return some Object to its Origin Location.

“Request for Assistance” as used herein shall mean a Notification about the need for help or assistance, typically by an AV from a Human Operator.

“Requirement” as used herein shall mean a necessary condition or specification that must be met for a particular purpose or function.

“RFID Label” or “RFID Tag” as used herein shall mean a label or tag equipped with an RFID chip and RFID antenna, allowing for detection and reading, including recognition/identification, by an RFID reader when the RFID Label or RFID Tag is sufficiently close to the RFID reader. There are both active and passive RFID labels/tags. This technology is used to detect and identify labeled or tagged items using Radio Frequency Identification.

“Robot Interaction Tag” or “Bot Interaction Tag” as used herein shall mean a (RTLS) Tag used to interact with Robots and Autonomous Vehicles such as Mobile Robots, triggering or changing certain actions and/or behaviors by one or more Robots.

“Route” or “Possible Route” as used herein shall mean a set of coordinates defining the location of a Pathway, such as a VAP, within an Environment. Also, a collection of selected Pathways and/or Pathway Sections that connect two Path Points (i.e., 2 Locations within the Environment). A Route may be (re)presented as a Virtual Element, by a computer system such as a Control System, on a digital representation of an Environment, such as a Map or Floor Plan or 3D rendering. A Route may have certain Properties and/or Rules associated with it.

“RTLS Anchor” or “RFID Anchor” or “Anchor” as used herein shall mean a sensor mounted in the Environment and used to help determine the location or position of one or more Tags present in the same Environment. Typically, a network of Anchors (also referred to as e.g. “antennas”, “receivers”, “readers”, “sensors”, or “beacons”) is mounted in the Environment, whereby Anchors and Tags exchange wireless (for example, RF) signals (using, for example, UWB, BLE, RFID, Wi-Fi, LoRa, 5G, GPS, GPS/RTK, or any other suitable wireless technology) to determine the positions and movements of the Tags, thereby determining the positions and movements of the Objects or People that the Tags are attached to or worn by.

“RTLS Tag” or “RFID Tag” or “Tag” as used herein shall mean tags or labels that are attached to the Objects or worn by the People being tracked using a Real-Time Location System. At times also referred to as, e.g., “RTLS Tags”, “RTLS Labels”, “RFID Tags”, “RFID Labels, “sensors,” “trackers,” or “labels.” RTLS Tags are a type of User Device and may contain buttons, speakers, buzzers, lights, microphones, and/or screens, to e.g., facilitate the receiving and sending of information.

“RTLS Tag Button” or “Tag Button” or “Button” as used herein shall mean a button on a Tag that can be manipulated by a Human Operator in certain ways (e.g. pushing the button); buttons may be “physical” or digital (e.g., in case a Tag has a UI or screen, buttons may be virtual and pressed using a touch screen) One or more Tag Buttons can possibly be pressed in different ways (e.g., short-press vs. long-press, single-press vs. double-press, pressing different button combinations consecutively or at the same time, etc.) to send different signals (and possibly trigger different behaviors and/or actions by e.g. certain VOPs in a certain Environment) using the same button or buttons.

“RTLS Tag Label” or “Tag Label” as used herein shall mean certain metadata associated with an RTLS Tag. Each Tag Label can be considered a variable, with a variable name (Label Name) and a variable value (Label Value).

“RTLS Tag Location” or “Tag Location” as used herein shall mean the Location of a Tag, as e.g., determined by the RTLS that the Tag is part of.

“RTLS Tag UI” or “Tag UI” as used herein shall mean the UI or User Interface, on a Tag; e.g., a screen that may be (but does not need to be) touch-enabled; in case of a touch-enabled UI, the UI may provide button functionality (in which case there may not be any physical buttons on the tag)

“RTLS Tag UID” or “Tag UID” as used herein shall mean a unique identifier for a Tag. Typically, a Tag UID consists of a string of alphanumerical characters that uniquely identifies the specific Tag involved. Typically, Tag UIDs cannot be configured or changed by “regular” Users, but are either factory-configured or managed by users that have the appropriate authority levels, such as “Admin” Users.

“Rule” as used herein shall mean a prescribed guideline that influences or controls the behavior of a VOP or Asset.

“Sensor” as used herein means an electronic device operable to quantify an ambient environmental condition, e.g., a device used to detect and/or measure physical properties or changes in the Environment.

“Station” as used herein shall mean a defined Location within an Environment (typically “fixed” or “stationary”, but at times “mobile” or “dynamic”) e.g., serving as a pick-up and/or drop-off point. A Station may be (re)presented as a Virtual Element, by a computer system such as a Control System, on a digital representation of an Environment, such as a Map or Floor Plan or 3D rendering. A Station may have certain Properties and/or Rules associated with it.

“Target” or “Target Point” or “Target Position” or “Target Location” as used herein shall mean a mobile or “dynamic” Location within the Environment, reflecting the position of some mobile Asset within the Environment, and typically provided by a Real-Time Location System. A Target may be represented as a Virtual Element, by a computer system such as a Control System, on a digital representation of an Environment, such as a Map or Floor Plan or 3D rendering. A Target may have certain Properties and/or Rules associated with it.

“Task” as used herein shall mean a specific action or operation or set of actions or operations (to be) performed by a VOP, i.e., a Person or Autonomous Vehicle such as a Mobile Robot, to achieve one or more desired outcomes or objectives, often involving some navigation and travel within an Environment. A Task may be represented as a Virtual Element, by a computer system such as a Control System, on a digital representation of an Environment, such as a Map or Floor Plan or 3D rendering. A Task may have certain Properties and/or Rules associated with it.

“Temporary VAP” or “Ad Hoc VAP” as used herein shall mean a VAP that is of a more “temporary” nature (to for example help address some temporary need), as opposed to an Existing VAP (also referred to as an Original VAP) which is of a more “predefined” or “static” nature.

“Trajectory” or “Planned Trajectory” as used herein shall mean a path or “line of travel,” as planned by a Control System, consisting of one or more Pathways or Path Sections, such as VAPs or VAP Sections, and possibly already partially or entirely traveled by a VOP, while operating within an Environment. Hence, while a Route shows the VAPs and/or VAP Sections where a VOP is theoretically or technically able to travel, the Trajectory is the actual combination of the specific VAPs and/or VAP Sections chosen for a VOP to actually travel from one location to another. A Trajectory may be represented as a Virtual Element, by a computer system such as a Control System, on a digital representation of an Environment, such as a Map or Floor Plan or 3D rendering. A Trajectory may have certain Properties and/or Rules associated with it. A Trajectory is typically part of a Navigation Plan.

“Transfer Tag” as used herein shall mean a tag, such as an RTLS Tag, that alerts or triggers and enables a VOP, such as a mobile robot, to transfer an Object from some Origin Location to some Destination Location.

“Travel” as used herein shall mean to travel, i.e., to physically move, or physical movement, typically between various locations within an Environment.

“Travel Path” as used herein shall mean the path (or “trajectory” or “route”) traveled within an Environment by a VOP, i.e., a Person or an Autonomous Vehicle such as a (mobile) Robot.

“User” as used herein shall mean a person interacting with an Automated Vehicle or Robot, possibly through the use of one or more Tags.

“User Device” as used herein shall mean a device used by a Human Operator for sending, receiving, storing, and processing information, such as Requests and Notifications. A User Device may e.g., be used to communicate certain information (for example, directions) from a Control System to one or more Persons utilizing the User Device. A User Device may also be used for viewing, interacting with, and modifying visual representations of the Environment and some or all the Virtual Elements that exist within or are associated with the Environment. User Devices can be mobile devices (such as a phones or tablet computers) carried by Human Operators, or wearable devices (such as a smart watches or smart glasses) worn by Human Operators. User Devices can also be desktop computers, laptops, or tablet computers that are present at/in/on workstations or Mobile Equipment used by Human Operators. User Devices can contain RTLS Tags or be trackable by an RTLS in a certain way. RTLS Tags are a type of User Device as well, and may contain buttons and/or screens to e.g., help with sending or receiving information.

“User Home Station” or “User's Home Station” as used herein shall mean the Location (e.g., a Station or Zone) that a User is typically associated with. For example, the typical workstation or work bench of a certain Operator.

“User ID” as used herein shall mean a unique ID for a User. (Possibly consisting of a User's Name, or parts of a User's Name, combined with any further character combination needed to make the User ID unique within the setup/environment.)

“User ID Tag” or “User Tag” as used herein shall mean a Tag that is being worn or carried by a User and helps to identify and/or track that User, while possibly also allowing the User to interact with Robots, including Mobile Robots and other types of Autonomous Vehicles. At times, a User Tag will have one or more buttons that can be pressed to e.g., send a signal. Such buttons can possibly be pressed in different ways (e.g., short-press vs. long-press, single-press vs. double-press, pressing different button combinations, etc.) to send different signals using the same button or buttons.

“User Live Location” or “User's Live Location” as used herein shall mean the real-time (or “live”) location of a User, as typically determined using the Tag Location of that User's User Tag.

“User Location at Time of Button-Press” or “User's Location at Time of Button-Press” as used herein shall mean the location of a User, as determined by the Tag Location of a Tag worn or carried by that User, at the time the User pushed a/the button on that Tag. Typically, a User would push one or more buttons, or button combinations, on his or her (personal) User Tag, but other Tags could be used at times.

“Virtual Approved Pathway” or “VAP” as used herein shall mean a type of Pathway that is both virtual and approved (i.e., a Pathway that is both a Virtual Pathway and an Approved Pathway), and that is defined by a set of coordinates within a certain coordinate system, and that comprises certain Properties and certain Rules. A VAP may be (re)presented as a Virtual Element, by a computer system such as a Control System, on a digital representation of an Environment, such as a Map or Floor Plan or 3D rendering. A VAP may have certain Properties and/or Rules associated with it.

“Virtual Element” as used herein shall mean anything that reflects some aspect or “element” of a (“physical”) Environment and which is defined digitally in a computer system, such as a Control System. A Virtual Element may have certain Properties and/or Rules associated with it. Virtual Elements (as well as some or all of their possible Properties and/or Rules) may be shown, by a computer system such as a Control System, on a digital representation of an Environment, such as a Map or Floor Plan or 3D rendering, including by using Augmented Reality (or “AR”).

“Virtual Pathway” as used herein shall mean a type of Pathway that is defined virtually, stored in a computer system (and that may not be visible to the human eye in the Environment).

“VOP” as used herein shall mean (Automated) Vehicle or Person. In plural, “VOPs” refers to “(Automated) Vehicles or Persons” or “(Automated) Vehicles or People.” VOP may also refer to a Class of (Automated) Vehicles or People, whereby “class” may also be referred to as “category” or “type” or “type” or “family.” The navigation and travel of Automated Vehicles may be influenced or controlled by Approved Virtual Pathways, as may the navigation and travel of People. Therefore, we at times refer to “(Automated) Vehicle or Person” as “VOP,” or to “(Automated) Vehicles or People” as “VOPs,” to be more concise in our explanations and descriptions. A VOP may be (re)presented as a Virtual Element, by a computer system such as a Control System, on a digital representation of an Environment, such as a Map or Floor Plan or 3D rendering. A VOP may have certain Properties and/or Rules associated with it. One Example of VOP may include Robot or Vehicle or Person, or: Class of Robots/Vehicles or People (“class” may also be referred to as for example, “category” or “type” or “family”).

“VOP Property” as used herein shall mean a property that applies to a VOP, for example: width, length, weight, load carrying capability, pulling, or pushing capability, or other specification.

“VOP Rules” as used herein shall mean Rules associated with a VOP (or Class of VOPs).

“Zone” or “Area” as used herein shall mean a specifically delineated area within a wider Environment, in 2D or 3D space. A Zone is characterized by its boundaries within the wider environment that it is part of, and used for e.g., organizing space, managing activities, and/or directing movements within the environment. Zones may be demarcated in certain ways (e.g., with lines) and identified in certain ways (e.g., with labels), whether in the physical (“real-world”) environment and/or in a virtual representation (“digital twin”) of the environment. A Zone may be (re)presented as a Virtual Element, by a computer system such as a Control System, on a digital representation of an Environment, such as a Map or Floor Plan or 3D rendering. A Zone may have certain Properties and/or Rules associated with it. (to e.g., help in establishing and maintaining control, safety, and efficiency by segmenting larger spaces into manageable, functional areas)

A number of embodiments of the present disclosure have been described. While this specification contains many specific implementation details, there should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. The drawings, and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims.

The headings used herein are for organizational purposes only and are not meant to be used to limit the scope of the description or the claims. As used throughout this application, the word “may” be used in a permissive sense (i.e., meaning having the potential to), rather than the mandatory sense (i.e., meaning must). Similarly, the words “include,” “including,” and “includes” mean “including, but not limited to.” To facilitate understanding, reference numerals have been used, where possible, to designate elements common to the figures.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” may be used interchangeably herein. It is also to be noted the terms “comprising,” “including,” and “having” may be used interchangeably.

Certain features that are described in this specification in the context of separate embodiments may also be implemented in combination in a single embodiment. Conversely, various features that are described in the context of a single embodiment may also be implemented in combination in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Certain features that are described in this specification in the context of separate embodiments may also be implemented in combination in a single embodiment. Conversely, various features that are described in the context of a single embodiment may also be implemented in combination in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Moreover, the separation of various system components in the embodiments described above should not be understood as requiring such separation in all embodiments, and it should be understood that the described program components and systems may generally be integrated together in a single software product or packaged into multiple software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

In certain implementations, multitasking and parallel processing may be advantageous. Nevertheless, it will be understood that various modifications may be made without departing from the spirit and scope of the claimed disclosure. Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but may have additional steps not included in the figures. A process may correspond to a method, a function, a procedure, a subroutine, a subprogram, or other process descriptor. When a process corresponds to a function, its termination may correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

What is claimed is:

1. An apparatus for real-time location system (RTLS) enabled human to automated vehicle (AV) interaction, the apparatus comprising:
a control system comprising a processor in logical communication with a memory storing executable code configured to be executable to communicate with a plurality of RTLS transceivers and RTLS anchors within an environment, and with a plurality of user devices; and
an autonomous vehicle (AV) equipped with a RTLS communication transceiver to interact with the control system;
wherein the control system is configured to determine a real-time location of the RTLS communication transceiver and generate location data at multiple points in time and provide navigation instructions to the AV based on the real-time location data; and
wherein the control system is further configured to assign tasks for the AV based on the real-time location data and metadata associated with the plurality of RTLS transceivers.

2. The apparatus of claim 1, wherein the RTLS communication transceiver comprises a button activatable by a User, said activation transmits a control signal to the AV to cause the AV to perform a specific task, and the control system is further configured to assign priority levels for the tasks assigned to the AV and generate an order of task execution based upon the priority levels.

3. The apparatus of claim 2, wherein the control system is further configured to dynamically update virtual approved pathways in response to changes in the environment detected by AV sensors and RTLS transceivers.

4. The apparatus of claim 2 wherein the specific task is determined by one or more of: a length of a button press, a quantity of sequential button presses, a length of a button press and a location of the RTLS communication transceiver comprising the button when the button is pressed by the User.

5. The apparatus of claim 3, wherein the AV is configured to autonomously select optimal travel routes based on both RTLS location data and sensor-derived environmental conditions.

6. The apparatus of claim 3, wherein the control system is configured to aggregate and analyze historical location data from the RTLS transceivers to optimize future AV task scheduling and prioritization.

7. The apparatus of claim 6, wherein the AV is configured to respect a human within a designated range via a communication comprising a light sequence, and maintaining a specified minimal distance from the human with the designated range.

8. The apparatus of claim 6, wherein the control system is configured to generate and manage geofenced safety zones that trigger AV behavioral modifications when the RTLS transceivers enter or exit such zones.

9. The apparatus of claim 6, wherein the AV is configured to utilize machine learning algorithms to adapt its behaviors over time based on interactions with human operators and objects tracked by the RTLS transceivers.

10. The apparatus of claim 9, wherein the control system is configured to provide real-time visualizations of AV and RTLS transceiver locations on user devices, including dynamic updates of virtual pathways and geofenced areas.

11. The apparatus of claim 10, wherein the AV is configured to autonomously engage and disengage with mobile accessories or carts equipped with the RTLS transceivers based on task assignments and the location data.

12. The apparatus of claim 10, wherein the control system is configured to send context-aware notifications to the human operators, including alerts for potential collisions, requests for assistance, and updates on AV task status.

13. The apparatus of claim 12, wherein the AV is configured to adjust its operational parameters, including speed, orientation, and stop position, based on real-time proximity to the human operators and other mobile equipment as determined by RTLS data.

14. The apparatus of claim 11, wherein the control system is configured to store and manage the metadata associated with the RTLS transceivers, including user preferences, task types, and destination information, to enable personalized AV interactions.

15. The apparatus of claim 12, wherein the AV is configured to perform context-dependent signaling, such as light or sound alerts, when approaching the human operators or entering designated zones as determined by RTLS location data.

16. The apparatus of claim 15, wherein the AV is configured to autonomously identify and avoid obstacles within the environment by combining the RTLS location data with sensor inputs.

17. The apparatus of claim 16, wherein the control system is configured to manage multiple environments and coordinate AV operations across geographically distributed locations using RTLS data.

18. The apparatus of claim 17, wherein the AV is configured to execute multi-step collaborative workflows with the human operators, including pick-up, delivery, and assistance tasks, triggered by RTLS transceiver events.

19. The apparatus of claim 18, wherein the control system is configured to dynamically reassign AV tasks in response to changes in human operator availability or location as determined by the RTLS transceivers.

20. The apparatus of claim 19, wherein the AV is configured to maintain minimum approach distances and adjust its behaviors based on user preferences stored in RTLS transceiver metadata.
